(19) United States
(12) Patent Application Publication
(10) Pub. No.: US 2025/0372920 A1
(43) Pub. Date: Dec. 4, 2025

(54) RELIABLE HIGH-SPEED, HIGHDENSITY CABLE CONNECTOR

(71) Applicant: Amphenol Commercial Products (Chengdu) Co., Ltd., Chengdu (CN)

(72) Inventors: Xiangjun He, Chengdu (CN); Chao Zou, Chengdu (CN); Yaohua Hou, Chengdu (CN)

(73) Assignee: Amphenol Commercial Products (Chengdu) Co., Ltd., Chengdu (CN)

(21) Appl. No.: 19/222,396

(22) Filed: May 29, 2025

(30) Foreign Application Priority Data
May 31, 2024 (CN) 202410703318.X
May 31, 2024 (CN) 202421238676.X
May 31, 2024 (CN) 202421241865.2

(51) Int. Cl. H01R 13/627; H01R 12/77; H01R 13/508; H01R 13/631

(52) U.S. Cl. CPC H01R 13/6275; H01R 12/772; H01R 12/774; H01R 13/508; H01R 13/631

(57) ABSTRACT

Reliable high-speed, high-density cable connector. The cable connector comprises a housing and a conducting assembly removably connected to the housing. The conducting assembly includes at least one flexible flat cable. A terminal position assurance (TPA) device is disposed from a top of the housing and configured to secure the conducting assembly to the housing in a locked state and allow the removal of the conducting assembly in an unlocked state. A connector position assurance (CPA) device is disposed from a side of the housing and configured to secure to a mating component. Such techniques can enable reliable high-speed, high-density connectors with replaceable cables, which can be used in harsh environments such as one presented by an automobile.

### CROSS-REFERENCE TO RELATED APPLICATIONS

This application claims priority to and the benefit of Chinese Patent Application No. 202410703318.X, filed on May 31, 2024. This application also claims priority to and the benefit of Chinese Patent Application No. 202421241865.2, filed on May 31, 2024. This application also claims priority to and the benefit of Chinese Patent Application No. 202421238676.X, filed on May 31, 2024. The contents of these applications are incorporated herein by reference in their entirety.

### TECHNICAL FIELD

The present disclosure generally relates to electronic systems, such as those including electrical connectors, used to interconnect electronic assemblies.

### BACKGROUND

Electrical connectors are used in many electronic systems. It is generally easier and more cost effective to manufacture an electronic system as separate electronic assemblies, which may be joined together with electrical connectors. Electrical connectors may be used for interconnecting assemblies so that the assemblies may operate together as part of an electronic system. Electrical connectors, for example, may be mounted onto printed circuit boards within two assemblies that are connected by mating the electrical connectors. In another electronic system, it may be impractical to join two printed circuit boards by directly mating electrical connectors on these printed circuit boards. For example, these printed circuit boards may be spaced so far apart in the electronic system that the electrical connectors mounted on the printed circuit boards cannot be directly connected.

In the electronic systems, assemblies may be interconnected through cables. The cables may be terminated with connectors that can mate with connectors mounted on printed circuit boards. In this way, the assemblies may be interconnected by plugging electrical connectors that are part of cable assemblies into electrical connectors mounted onto printed circuit boards. In another electronic system architecture, an electrical connector terminated to a cable may be mated with another electrical connector terminated to another cable.

Modern automobiles are examples of electronic systems with assemblies connected through cables. For example, the automobiles may include electronic control units (ECUs) for controlling various automotive systems, such as engines, transmission control units (TCUs), security systems, emission control, lighting, advanced driver assistance systems (ADASs), entertainment systems, navigation systems and cameras. The ECUs may be manufactured as separate assemblies that are connected by one or more cables routed between the assemblies. To simplify manufacturing, an assembly may include one or more cables terminated with an electrical connector, which can be mated to another electrical connector terminated to other cables or attached to a circuit board within another assembly.

### SUMMARY

Aspects of the present disclosure relate to reliable high-speed, high-density cable connectors.

Some embodiments relate to a cable connector. The cable connector may include a housing; a conducting assembly at least partially disposed inside the housing; and a connector position assurance (CPA) device separated from the conducting assembly by the housing. The CPA device may include a first member disposed on the housing and movable between a first locked state and a first unlocked state, a second member disposed on the first member and movable between a second locked state and a second unlocked state, wherein, when the first member is in the first locked state, the first member blocks the second member from moving from the second locked stated to the second unlocked state, and a third member disposed between the first member and the second member and configured to releasably engage a mating component.

Optionally, the first member is movable in a mating direction in the first unlocked state; and the second member is pivotable in the second unlocked state.

Optionally, the third member is movable between a third locked state and a third unlocked state; and the third member is in the third locked states when the first and second members are in the first and second locked state, and in the third unlocked state when the second member is pivoted to engage the third member.

Optionally, the first and second members comprise plastic; and the third member comprises metal.

Optionally, the housing comprises a front housing member and a rear housing member; the first member is disposed on the rear housing member and extends to the front housing member; the second member is disposed on the front housing member; and the third member is disposed in the rear housing member and extends through the first member to the front housing member.

Optionally, the first member comprises a first body comprising a first actuator operable between a rest position and a first actuated position, and a first locking part configured to engage the second member when the first member is in the first locked state; the first actuator is blocked by the housing in the mating direction when the first actuator is in the rest position; and the first actuator is unblocked by the housing when the first actuator is in the first actuated position, such that the first member is movable in the mating direction the first unlocked state.

Optionally, the first actuator comprises a cantilever and a pair of wings protruding from opposite sides of a free end of the cantilever, respectively; and the housing comprises a pair of limiters configured to block the pair of wings in the mating direction, respectively.

Optionally, the first member further comprises a first intermediate part between the first locking part and the first body, the first intermediate part comprising a gap; the third member comprises a third locking part configured to secure to the mating component, a third tail, and a third intermediate part between the third locking part and the third tail; and the third intermediate part is narrower than both the third locking part and at least part of the third tail, and extends through the gap of the first intermediate part of the first member.

Optionally, the third member comprises a third opening elongated in the mating direction; and the first locking part is configured to engage the second member through the third opening in the first locked state and be slidable in the third opening in the first unlocked state.

Optionally, the first and second members are configured to engage each other in the first and second locked states and to disengage each other in the first and second unlocked states.

Some embodiments relate to a cable connector. The cable connector may include a housing; and a conducting assembly removably connected to the housing, the conducting assembly comprising one or more flexible flat cables having a mating contact end extending into the housing, a mounting end disposed outside the housing, and an interconnecting portion between the mating contact end and the mounting end. The mating contact end of the one or more flexible flat cables may have a first surface and a second surface; each of the first surface and the second surface may comprise a plurality of contact pads arranged in a row parallel to a first direction; and the first surface and the second surface may be opposite each other in a second direction perpendicular to the first direction.

Optionally, the cable connector comprises a terminal position assurance (TPA) device configured to secure the conducting assembly to the housing in a locked state and allow the removal of the conducting assembly in an unlocked state. The TPA device comprises a first locking member removably connected to the housing, and a strain relief component arranged on the first locking member, and a second locking member pivotably connected to the housing, the second locking member engaging the conducting assembly and configured to pivot to disengage the conducting assembly.

Optionally, the first locking member includes a beam engaging the housing and configured to disengage the housing by a tool.

Optionally, the strain relief component is sleeved on the first locking member; and/or the strain relief component comprises an elastic material.

Optionally, the interconnecting portion is clamped between the housing and the strain relief component; the conducting assembly comprises a reinforcing plate having a cut configured for receiving the second locking member; and the mating contact end of the one or more flexible flat cables is attached to the reinforcing plate.

Some embodiments relate to a cable connector. The cable connector may include a housing; a conducting assembly removably connected to the housing, the conducting assembly comprising one or more flexible flat cables having a mating contact end extending into the housing, a mounting end disposed outside the housing, and an interconnecting portion between the mating contact end and the mounting end; and a terminal position assurance (TPA) device mechanically engaging the one or more flexible flat cables so as to block withdrawal of the conducting assembly.

Optionally, the TPA device comprises a first locking member removably connected to the housing, and a strain relief component arranged on the first locking member and pressing the one or more flexible flat cables against the housing.

Optionally, the TPA device comprises a second locking member pivotably connected to the housing, the second locking member engaging the conducting assembly and configured to pivot to disengage the conducting assembly.

Optionally, the housing comprises a front housing member and a rear housing member, and the conducting assembly passes through the rear housing member and extends into the front housing member; the first locking member is removably connected to the rear housing member; and the second locking member is pivotably connected to the front housing member.

Optionally, the TPA device is disposed from a top of the housing; the cable connector comprise a connector position assurance (CPA) device disposed from a side of the housing and separated from the conducting assembly by the housing; and the CPA device comprises a first member disposed on the rear housing member and extending to the front housing member, a second member disposed on the front housing member, and a third member disposed in the rear housing member and extending through the first member to the front housing member.

Some embodiments relate to a plug connector. The plug connector may comprise a first housing, a first conducting assembly held by the first housing, and a connector position assurance device including a first member, a second member, and a third member. The first member may be movable between a first locked state and a first unlocked state. The first member may be configured to engage with the first housing for locking the second member when in the first locked state and to disengage with the first housing for releasing the second member when in the first unlocked state. The second member may be configured to be movable between a second locked state and a second unlocked state to engage with the first member and the third member, respectively. The third member may be configured to be movable between a third locked state for locking a mating socket connector and a third unlocked state for engaging with the second member to release the socket connector.

Optionally, the first member may include a first body including a first actuator and a first locking part. The first body may be operable such that the first member is movable between the first locked state and the first unlocked state along a first direction. The first locking part may be configured to lock the second member when the first member is in the first locked state and release the second member when the first member is in the first unlocked state.

Optionally, the first actuator may be operable between a rest position and a first actuated position in a second direction different from the first direction. The first actuator may be blocked by a limiter on the first housing along the first direction when the first actuator is in the rest position, such that the first member is kept in the first locked state. The first actuator may be released by the limiter when the first actuator is in the first actuated position, such that the first member is moveable to the first unlocked state.

Optionally, the limiter may have a length in the first direction. The first actuator may be configured to abut against an end of the limiter when in the rest position, and climb onto the end of the limiter and slide along the limiter when in the first actuated position, such that the first member is moveable to the first unlocked state.

Optionally, the first actuator may include a cantilever and a pair of wings protruding from two sides of a free end of the cantilever, respectively. There may be a pair of the limiters for blocking the pair of wings in the first direction, respectively.

Optionally, the first actuator may comprise a projection projecting beyond an outer surface of the first body. A protruding protector may be disposed on the outer surface of the first body and around the projection.

Optionally, the first member may further include a first intermediate part connected between the first locking part and the first body. The third member may include a third locking part, a third tail, and a third intermediate part. The third locking part may be configured to lock and release the socket connector. The third locking part and the third tail may be located at opposite ends of the third member respectively. The third intermediate part may be connected between the third locking part and the third tail. A width of the third intermediate part may be less than a width of the third locking part and less than a width of at least part of the third tail. The first intermediate part may include a gap, and the third intermediate part may pass through the gap.

Optionally, widths of the third locking part and the at least part of the third tail may be greater than a width of the gap.

Optionally, the width of the third intermediate part may be adapted to the width of the gap.

Optionally, the second member may be configured to be pressed into the second unlocked state towards an interior of the first housing. The first locking part may be located on an inner side of the second member to abut against the second member towards an outer side of the first housing when the first member is in the first locked state, such that the second member is kept in the second locked state.

Optionally, the third member may include a third opening extending in the first direction, and the first locking part may be engaged with the second member through the third opening and slidable in the third opening.

Optionally, the first housing may include a mounting channel extending along a first direction. The first member may be movable in the mounting channel between the first locked state and the first unlocked state in the first direction, and the mounting channel may limit the movement range of the first member at least in the first direction.

Optionally, the first member may include a first body. The first body may comprise a first wall, a second wall and a third wall. The first wall may include the first actuator being operable such that the first member is moveable between the first locked state and the first unlocked state. The second wall and the third wall may be arranged on opposite sides of the first wall. The second wall and the third wall may include a first snapping portion and a second snapping portion, respectively. The first housing may include a first slot and a second slot elongated in the first direction. The first snapping portion and the second snapping portion may be snapped into the first slot and the second slot in a second direction perpendicular to the first direction, respectively, and be slidable along the first slot and the second slot, respectively.

Optionally, the second member and the third member may be both located within the mounting channel. The third member may be fixed in place by the second member and the first housing along the first direction.

Optionally, the first direction may be parallel to a mating direction of the plug connector mated to the socket connector.

Optionally, the third member may include a third locking part and a third tail. The third locking part may be configured to lock and release the socket connector. The third locking part and the third tail may be located at opposite ends of the third member respectively. The third tail may include a connecting portion, an intermediate portion and an end portion connected successively in a mating direction of the plug connector mated to the socket connector. The connecting portion may be connected to the third locking part. The intermediate portion may be bent towards an interior of the first housing and abut against the first housing. The end portion may be oriented towards an exterior of the first housing and abut against the first housing. The first housing may comprise a fulcrum that biases the connecting portion towards the exterior of the first housing.

Optionally, the end portion of the third tail may be arranged with a third wing on each side. In an insertion direction of the plug connector into the socket connector, the third wing may abut against the first housing.

Optionally, the third member may further include a protruding third limiter. The second member may abut against the third limiter in a pull-out direction of the plug connector from the socket connector.

Optionally, the third member may be made of a metal sheet.

Optionally, the first housing may include a front housing member and a rear housing member. The first conducting assembly may extend into the front housing member. The first member may be installed into the rear housing member and extend into the front housing member. The second member may be installed between the front housing member and a portion of the first member may extend into the front housing member. The third member may be installed into the rear housing member and extending into the front housing member.

Some embodiments relate to a socket connector is provided. The socket connector may comprise a second conductive assembly, a second housing and a cage. The second conductive assembly may be configured for electrical connection to a first conductive assembly on a plug connector inserted into the socket connector. The second conductive assembly may be held by the second conducting assembly. The cage may enclose the second housing and comprise a connector locking portion configured to engage with a connector position assurance device on the plug connector.

Optionally, the connector locking portion may include a first connector locking portion and a second connector locking portion spaced apart along a mating direction of the plug connector to the socket connector. Each of the first connector locking portion and the second connector locking portion may be capable of being locked with the connector position assurance device on the plug connector.

Optionally, the cage may be formed by a metal sheet, and opposite edges of the metal sheet may have mortise and tenon such that the edges of the metal sheet are connected to each other.

Optionally, the cage may include a board lock configured to fix to a circuit board.

Optionally, an inner surface of a front part of the cage may be spaced apart from an outer surface of the second housing to form a space for receiving an insertion portion of the plug connector. The connector locking portion may be arranged in the space.

Some embodiments relate to a method for operating a plug connector. The method may comprise moving a first member from a first locked state to a first unlocked state to release a second member in a second locked state; and moving the second member from the second locked state to a second unlocked state to unlock a third member. The third member may be in a third locked state when the second member is in the second locked state; and the third member may be in a third unlocked state to release a socket connector mated to the plug connector when the second member is in the second unlocked state.

Optionally, the step of moving the first member from the first locked state to the first unlocked state includes: pressing a first actuator of the first member in the first locked state; and moving the first member along a first direction such that the first member moves to the first unlocked state.

Some embodiments relate to a connector. The connector may comprise a conducting assembly, a housing, and a terminal position assurance device. The conducting assembly may be inserted into the housing. The terminal position assurance device may include a first locking member and a strain relief component arranged on the first locking member. The first locking member may have a first holding position and a first releasing position. The conducting assembly may be clamped between the housing and the strain relief component when the first locking member is in the first holding position; and the conducting assembly may be detachable from the housing when the first locking member is in the first releasing position.

Optionally, the first locking member may be detachably connected to the housing between the first holding position and the first releasing position.

Optionally, the first locking member may include a beam engaged with the housing, and the beam may be configured to be unengaged with the housing by a tool.

Optionally, the strain relief component may be sleeved on the first locking member.

Optionally, the strain relief component may be made of an elastic material.

Optionally, the conducting assembly may include a flexible flat cable including a mating contact end extending into the housing, a mounting end outside the housing and an interconnecting portion connected between the mating contact end and the mounting end. The interconnecting portion may be clamped between the housing and the strain relief component when the first locking member is in the first holding position.

Optionally, the interconnecting portion may be bent under a pressure of the first locking member.

Optionally, the interconnecting portion may be offset in relative to the mating contact end toward a side of the housing.

Optionally, the terminal position assurance device may further include a second locking member having a second holding position and a second releasing position. The second locking member may be connected to the housing and engaged with the conducting assembly when the second locking member is in a second holding position, and the second locking member may release the conducting assembly when the second locking member is in the second releasing position.

Optionally, the conducting assembly may include a flexible flat cable and a reinforcing plate. The flexible flat cable may include a mating contact end extending into the housing, a mounting end outside the housing and an interconnecting portion connected between the mating contact end and the mounting end. The mating contact end may be attached to the reinforcing plate. An edge of the reinforcing plate may comprise a cut for receiving the second locking member.

Optionally, the second locking member may be pivotably connected to the housing between the second holding position and the second releasing position.

Optionally, the housing may have a first side and a second side opposite in a lateral direction perpendicular to a mating direction of the connector to a mating connector. There may be two second locking members symmetrically arranged on the first side and the second sides.

Optionally, the housing may comprise a front housing member and a rear housing member, and the conducting assembly may pass through the rear housing member and extends into the front housing member.

Optionally, the first locking member may be connected to the rear housing member, and the second locking member is connected to the front housing member.

Optionally, the connector may further include a shaft. One end of the shaft may be connected to the front housing member. The second locking member may include a pivot hole. The shaft may be inserted into the pivot hole such that the second locking member is pivotable between the second holding position and the second releasing position. The rear housing member may be connected to the front housing member, and the rear housing member may restrict the second locking member from removing from the shaft at the other end of the shaft. Optionally, the connector may be a plug connector.

Some embodiments relate to a cable connector. The cable connector may comprise a housing and a conducting assembly. The conducting assembly may include at least one flexible flat cable. Each of the at least one flexible flat cable may include a mating contact end, a mounting end and an interconnecting portion connected between the mating contact end and the mounting end. The mating contact end of the at least one flexible flat cable may extend into the housing, and the mounting end of the at least one flexible flat cable may be located outside the housing. The mating contact end of the at least one flexible flat cable may have a first surface and a second surface. Each of the first surface and the second surface may include a plurality of contact pads arranged in a row parallel to a first lateral direction. The first surface and the second surface may be opposite each other in a second lateral direction perpendicular to the first lateral direction.

Optionally, the conducting assembly may be detachably connected to the housing.

Optionally, the cable connector may further include a first locking member having a first holding position and a first releasing position. The interconnecting portion may be clamped between the housing and the first locking member when the first locking member is in the first holding position. The first conducting assembly may be detachable from the housing when the first locking member is in the first releasing position.

Optionally, the cable connector may further include a strain relief component attached to the first locking member. The interconnecting portion and the first locking member may clamp a portion of the strain relief component when the first locking member is in the first holding position.

Optionally, the strain relief component may be sleeved on the first locking member.

Optionally, the strain relief component may be made of an elastic material.

Optionally, the interconnecting portion may be bent under a pressure of the first locking member.

Optionally, the interconnecting portion may be offset in relative to the mating contact end toward a side of the housing.

Optionally, the first locking member may include a beam engaged with the housing, and the beam may be configured to be unengaged with the housing by a tool.

Optionally, the conducting assembly may further include a reinforcing plate in the housing, and the mating contact end may be attached to the reinforcing plate.

Optionally, the at least one flexible flat cable may include a first flexible flat cable and a second flexible flat cable. The mating contact end of the first flexible flat cable may include the first surface and a third surface opposite the first surface in the second lateral direction. The mating contact end of the second flexible flat cable may include the second surface and a fourth surface opposite the second surface in the second lateral direction. The third surface and the fourth surface may be opposite to each other.

Optionally, the third surface and the fourth surface may be attached to a reinforcing plate, and the reinforcing plate is fixed to the housing.

Optionally, the cable connector may further include a second locking member having a second holding position and a second releasing position. The second locking member may be fixed to the housing and engaged with the reinforcing plate when the second locking member is in the second holding position. The second locking member may release the reinforcing plates when the second locking member is in the second releasing position.

Optionally, an edge of the reinforcing plate may be arranged with a cut, and the second locking member may be inserted into the cut when in the second locking position.

Optionally, the housing may include a front housing member, a shaft and a rear housing member. One end of the shaft may be connected to the front housing member, the second locking member including a pivot hole. The shaft may be inserted into the pivot hole such that the second locking member is pivotable between the second holding position and the second releasing position. The rear housing member may be connected to the front housing member and restricting the second locking member from removing from the shaft at the other end of the shaft.

Optionally, the cable connector may be a plug connector.

Some embodiments relate to an electrical system. The electrical system may comprise a connector described herein.

The techniques described herein may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a portion of an electronic system comprising a plug connector and a socket connector, according to some embodiments;

FIG. 2 is a perspective view of the electronic system of FIG. 1, showing the plug connector and the socket connector disconnected from each other;

FIG. 3 is a partial cross-sectional view of the electronic system of FIG. 1, taken along a plane perpendicular to the thickness direction;

FIG. 4 is a top, front perspective view of the plug connector of the electronic system of FIG. 1;

FIG. 5 is an exploded perspective view of the plug connector of FIG. 4;

FIGS. 6A and 6B are partial cross-sectional views of the plug connector of FIG. 4, taken along a plane perpendicular to the thickness direction, showing a first member of a connector position assurance (CPA) device of the plug connector in first locked and unlocked states, respectively;

FIG. 7A is a partial cross-sectional perspective view of the plug connector of FIG. 4, taken along a plane perpendicular to the thickness direction;

FIGS. 7B and 7C are partial rear views of the plug connector of FIG. 4, showing an actuator C of the first member of the CPA device in a rest position and a first actuated position, respectively;

FIG. 8A is a perspective view of a front housing member and a rear housing member of the plug connector of FIG. 4;

FIG. 8B is an elevation view of the plug connector of FIG. 4, with a second member of the CPA device of the plug connector hidden;

FIGS. 9A and 9B are perspective views of the first member of the CPA device of the plug connector of FIG. 4;

FIGS. 10A and 10B are perspective views of the second member of the CPA device of the plug connector of FIG. 4;

FIG. 11A is a perspective view of a third member of the CPA device of the plug connector of FIG. 4;

FIG. 11B is a partial cross-sectional perspective view of the plug connector of FIG. 4, taken along a plane perpendicular to the thickness direction, showing a first housing mounted with the third member of the CPA device;

FIG. 11C is a partial cross-section view of the plug connector of FIG. 11B, showing the third member of the CPA device engaging the first housing;

FIG. 12 is a perspective view of a first conducting assembly of the plug connector of FIG. 4;

FIG. 13 is a perspective view of the plug connector of FIG. 4, with a first locking member of a terminal position assurance (TPA) device exploded;

FIG. 14A is a cross-sectional view of the plug connector of FIG. 4, taken along a plane perpendicular to a width direction;

FIG. 14B is a cross-sectional view of the plug connector of FIG. 4, taken along a plane perpendicular to the mating direction;

FIG. 15A is a perspective view of the first locking member of the TPA device of the plug connector of FIG. 4, with a strain relief component hidden;

FIG. 15B is a perspective view of the first locking member of FIG. 15A, showing the strain relief component;

FIG. 16A is a perspective view of the plug connector of FIG. 4, showing a second locking member of the TPA device in a second unlocked state;

FIG. 16B is a perspective view of the plug connector of FIG. 16A, with the CPA device hidden;

FIG. 17 is a perspective view of the socket connector of the electronic system of FIG. 1; and

FIG. 18 is an exploded perspective view of the socket connector of FIG. 17.

### DETAILED DESCRIPTION

The Inventors have recognized and appreciated connector design techniques that enable high-speed, high-density cable connectors that may operate reliably in a harsh environment, such as may occur in an automobile. For example, with the rapid development of new energy vehicles, many key automotive systems are progressively adopting electronic control. These electronic control systems typically include a large number of modules that need to be interconnected. Techniques described herein enable high-speed, high-density interconnections that are robust for potential vibrations and movements presented by automobiles. Techniques described herein also enable rapid connection and disconnections, which can reduce assembly complexity and cost, and facilitate debugging and maintenance. According to aspects of the present disclosure, a cable connector may include a housing and a conducting assembly removably connected to the housing.

The conducting assembly may include at least one flexible flat cable. A terminal position assurance (TPA) device may be operated from either or both of the top and bottom of the housing and configured to secure the conducting assembly to the housing in a locked state and allow the removal of the conducting assembly in an unlocked state. A connector position assurance (CPA) device may be disposed from a side of the housing and configured to secure to a mating component.

In some embodiments, the conducting assembly may include a flexible flat cables (FFC). The FFC may include a flat conductor layer having a plurality of flat conductors laid in a plane, and insulating layers covering both surfaces of the conductor layer of an interconnecting portion of the FFC. The conductors having length and width both significantly greater than thickness thereof, have excellent performance for the transmission of high-frequency signal. The FFC may be twisted or folded to bend freely in at least one direction. The FFC may carry both power and data signals. A shield, such as copper foil, may be attached onto a surface of the insulating layers, to increase the performance of electromagnetic compatibility (EMC). The connector may be configured such that the FFC may be replaced without discarding the entire connector during maintenance or repair. Techniques describe herein enable the connector to be configured for any combination of signal and power, by changing the FFC, but not any other component of the connector.

In some embodiments, the TPA device may be configured for locking the FFC to the housing of the connector and releasing the FFC from the housing quickly and easily. A user may select a suitable length of FFC as needed, and install it to the connector (such as, a plug connector) simply. In the later maintenance, it is also possible to detach the FFC, and replace a new FFC or repair the FFC that is less damaged. In some embodiments, the TPA device may include a first locking member and a strain relief component arranged on the first locking member. The first locking member may be rigid and installed onto the housing. The strain relief component may be arranged on the surface of the first locking member for clamping the FFC together with the housing. The first locking member may be inserted through an opening of the housing and latched in the housing such that the strain relief component presses against the FFC. The housing may also be rigid. If the FFC is clamped between the first locking member and the housing, the FFC may be damaged. The strain relief component on the first locking member may protect the FFC held to the housing from being damaged.

In some embodiments, the first locking member may be disposed onto the flexible part of the FFC. In this way, the external force may mainly concentrate on the flexible part and be borne by the insulating layers of the FFC. Optionally, the flexible part of the FFC may be curved between the first locking member and the housing, such that the friction may be increased and the FFC may be reliably fixed to the housing. The first locking member may be installed to the housing from one side of the housing along a lateral direction, and the FFC may be bent toward the opposite side of the housing. Therefore, sufficient space can be left in the housing to install a relatively large first locking member without increasing the size of the housing along the lateral direction. The first locking member may have an improved mechanical strength and may be easily operated (such as, installed and detached) by a user. Optionally, the first locking member is locked to the housing via beams. The beams may be released with a tool, such that the FFC cannot force the first locking member out of the housing even if the bent portion of the FFC tends to be straightened when subjected to a large tension.

In some embodiments, a second locking member may fix a reinforcing plate to the housing. The second locking member may share the tension applied onto the FFC and also keep the terminals on the reinforcing plate in position. In this way, during the insertion of the electrical connector into a mating electrical connector, the reinforcing plate cannot retract into the housing. Optionally, a cut may be provided on the edge of the reinforcing plate, and a second locking member may be inserted into the cut to fix the reinforcing plate. Optionally, the second locking member may be pivotably connected to the housing. The second locking member may not protrude from the outer surface of the housing when being pivoted to a locking position for locking to the reinforcing plate. Optionally, the second locking member may include a protrusion, which may is engaged with the housing when the second locking member is in the locking position. The second locking member may be unlocked without a tool.

In some embodiments, the connector position assurance (CPA) device may be configured to secure the connector to a mating connector. The CPA device may include a first member, a second member and a third member. In some embodiments, the first member may be disposed on the housing and movable between a first locked state and a first unlocked state. The second member may be disposed on the first member and movable between a second locked state and a second unlocked state. The first and second members may be configured to engage each other in the first and second locked states and to disengage each other in the first and second unlocked states. The third member may be disposed between the first member and the second member and configured to secure to a mating component. The first member may be movable in a mating direction in the first unlocked state. The second member may be pivotable in the second unlocked state. The third member may be movable between a third locked state and a third unlocked state. The third member may be in the third locked states when the first and second members are in the first and second locked state, and in the third unlocked state when the second member is pivoted to engage the third member.

In some embodiments, the second member may be locked and unlocked by operating the first member, and the third member may be locked and unlocked by operating the second member. Two mating connectors may be locked and unlocked to each other by the third member. The second member in the locked state may be engaged with the first member, and thus the second member cannot be operated. The second member in the unlocked state is just enough to unlock the third member. Therefore, after the first member and the second member are unlocked successively, the third member is unlocked, and the two connectors may be separated accordingly. In this way, the locking reliability of the CPA device is increased, but the unlocking operation does not significantly become complex. Optionally, a fourth member may be provided besides the first member and the third member to further increase the reliability of the CPA device. In this case, a user may be required to perform three unlock steps. Even if a part of members in the CPA device may fail due to vibration and impacts after an extended period of use, the required interactions among the multiple parts of the CPA device may prevent the mating connectors from completely separating for a brief period of time, thereby preventing serious accidents caused by accidental disconnection of critical connectors in an automobile.

In some embodiments, the first member may include a first actuator. The first member may be movable along a first direction to unlock the second member. The first actuator may be configured to be operated by two external forces in different directions from a user successively for unlocking the first member. Exemplarily, the housing may be provided with a limiter. The first actuator may abut against an end of the limiter when the first member is in its locked state. The user may operate the first actuator along a second direction different from the first direction so that the first actuator may step across the end of the limiter, and then pull the first actuator along the first direction. The first member may be switched to its unlock position under the movement of the first actuator along the first direction. Optionally, the first actuator may always slide on the limiter during the movement of the first member towards its unlocked state along the first direction. In this way, if the first member is desired to return to its locked state, the first actuator may be simply pushed in the first direction and the first actuator may return to its rest position on its own when it is beyond the end of the limiter.

Optionally, there is a pair of the CPA devices located on two sides of the housing, respectively. In this way, uniform locking forces may be provided between the mating connectors. Optionally, the second members of the CPA devices may be configured to be pressed to respective unlocked states towards the interior of the housing for unlocking respective third members. Therefore, the connector may be detached from the mating connector after the second members are pressed.

In some embodiments, the housing may include a front housing member near a mating connector and a rear housing member away from the mating connector. Exemplarily, the second member of the CPA device may be installed onto the front housing member. Rear portions of the first member and the third member may be fixed to the rear housing member, but front portions of the first member and the third member may extend into the front housing member. The front portion of the first member extending into the front housing member may be configured for engaging with the second member, and the front portion of the third member extending into the front housing member may be configured for engaging with the mating connector. Exemplarily, the first locking member may be installed to the rear housing member. The front housing member may be connected to the rear housing member for installing the second locking member in place.

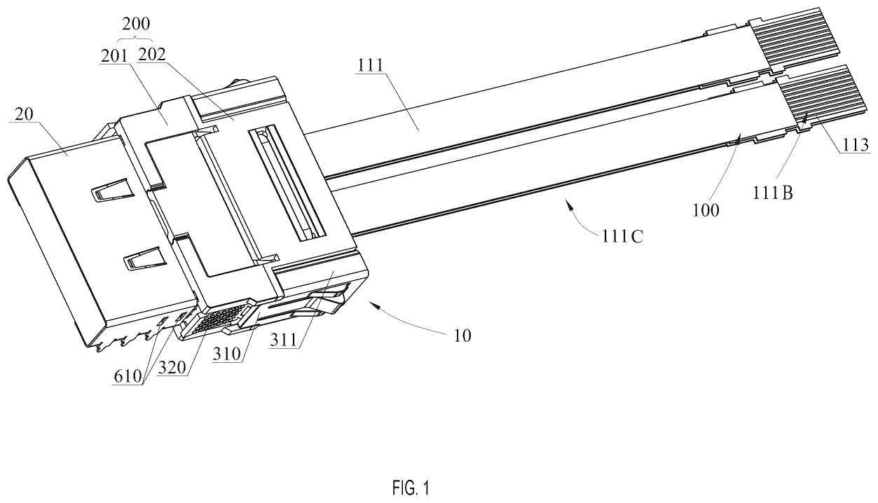

FIGS. 1 to 3 show a part of an electronic system, such as that may be used in an automobile, for interconnecting a plurality of electronic devices in the electronic system. As shown, the electronic system may include a plug connector 10 and a socket connector 20 that are mated and detachably connected to each other. The socket connector 20 may be installed on a circuit board (not shown). The plug connector 10 may be connected with a cable. The plug connector 10 may be electrically connected to an electronic device, such as another circuit board, by the cable to allow a certain distance between the electronic device and the circuit board. The cable may include Flexible Flat Cable (FFC). The plug connector 10 and socket connector 20 provide an interconnection between the electronic device and the circuit board. For example, the circuit board installed with the socket connector 20 may be fixed to another electronic device. In harsh environments such as those presented by automobiles, the electronic system may provide the transmission of power and/or data signals while withstanding vibration.

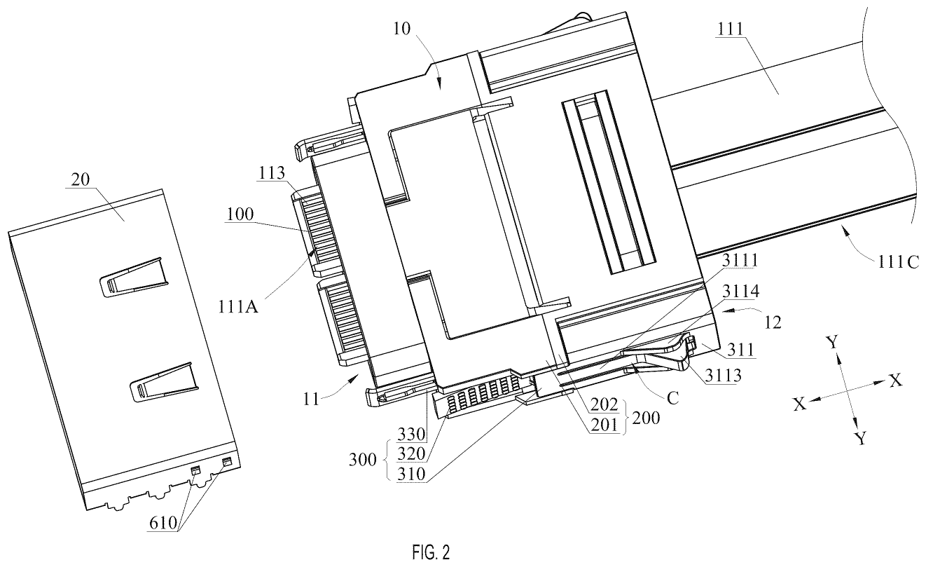

FIGS. 2, 4 and 5 show the plug connector 10 according to an embodiment of the present disclosure from different aspects. For clear and concise description, a mating direction X-X, a first lateral direction Y-Y and a second lateral direction Z-Z may be illustrated. The mating direction X-X may refer to a direction, along which the plug connector 10 is mated to the socket connector 20. The mating direction X-X may include an inserting direction of the plug connector 10 into the socket connector 20 and a pull-out direction of the plug connector 10 separated from the socket connector 20. The inserting direction may be opposite to the pull-out direction. The first lateral direction Y-Y and the second lateral direction Z-Z may be perpendicular to the mating direction X-X and the first lateral direction Y-Y and the second lateral direction Z-Z may be perpendicular to each other. Also, the first lateral direction Y-Y and the second lateral direction Z-Z may be referred to as the width and thickness directions of the plug connector 10.

The plug connector 10 may include a first conducting assembly 100. The first conducting assembly 100 may include a flexible flat cable 111, and the flexible flat cable 111 may include a plurality of contact pads 113. The plurality of contact pads 113 of the plug connector 10 and the plurality of terminals 400 of the socket connector 20 may be in electrical contact, respectively, to transmit signals and/or power between the plug connector 10 and the socket connector 20, when the plug connector 10 are mated to the socket connector 20. The first conducting assembly 100 may be held by a first housing 200 of the plug connector 10. Exemplarily, the plurality of contact pads 113 may be golden fingers formed on the flexible flat cable 111. Exemplarily, the first conducting assembly 100 may include a plurality of terminals. Each of the terminals may be a separate metal piece and be installed in a respective mounting channel of the first housing 200. Exemplarily, the first housing 200 may be molded with insulating materials, such as plastics. Plastics may include but be not limited to liquid crystal polymers (LCP), polyphenylene sulfite (PPS), high-temperature nylon or poly-p-phenylene oxide (PPO), or polypropylene (PP), or other materials may be used. In some cases, plastics may be thermosetting plastics. In some cases, insulating plastics may include such as a fiberglass-reinforced insulating material.

The plug connector 10 may include a CPA device 300. In the illustrated embodiment, two CPA devices 300 are included. The two CPA devices 300 are symmetrically arranged on two sides of the first housing 200 opposed along the first lateral direction Y-Y, and are structurally mirror images of each other.

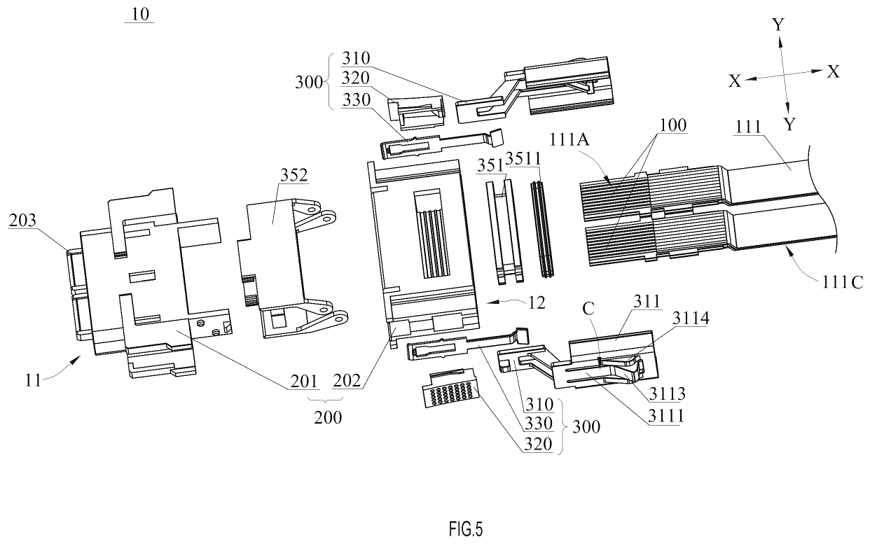

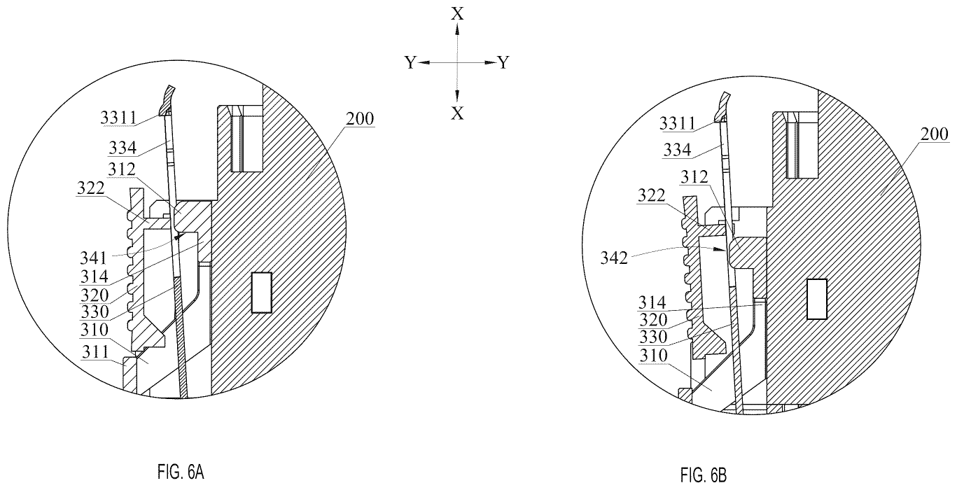

The CPA device 300 may include a first member 310, a second member 320, and a third member 330. The first member 310 is movable between a first locked state 341 (e.g., as shown in FIG. 6A) and a first unlocked state 342 (e.g., as shown in FIG. 6B). The first member 310 is configured to engage with the first housing 200 for locking the second member 320 when in the first locked state 341. The first member 310 is also configured to disengage with the first housing 200 for releasing the second member 320 when in the first unlocked state 342. The second member 320 is configured to be movable between a second locked state (e.g., as shown in FIG. 6A) and a second unlocked state (e.g., a position after the second member 320 shown in FIG. 6B is pressed to the right), to engage with the first member 310 and the third member 330, respectively. The third member 330 is configured to be movable between a third locked state for locking the mating socket connector 20 and a third unlocked state for engaging with the second member 320 to release the socket connector 20.

Exemplarily, the plug connector 10 may include a first mating portion 11 and a first tail portion 12. The first mating portion 11 is structurally complementary to a second mating portion 21 of the socket connector 20 so that the contact pads 113 may be precisely aligned with the terminals 400 when the plug connector 10 is inserted into the socket connector 20. The first conducting assembly 100 may extend from the first mating portion 11 to the first tail portion 12. The first tail portion 12 is used for being installed to an electronic device, such as a circuit board. Or, the first conducting assembly 100, such as that includes a cable, may extend beyond the first tail portion 12 to connect to an electronic device. In the illustrated embodiment, the first mating portion 11 and the first tail portion 12 are opposed to each other along the mating direction X-X. In other embodiments not shown, the first mating portion 11 and the first tail portion 12 may be perpendicular to each other or at any other suitable angle.

The plug connector 10 may be locked to the socket connector 20 by the third member 330 in the third locked state. The third member 330 may be able to stay in the third locked state. Exemplarily, the third member 330 may be kept in the third locked state by its own bias force or by a bias force from another component. The third member 330 may be moved to the third unlocked state by movement of the second member 320, and the movement of the second member 320 is limited by the first member 310. When the first member 310 is in the first locked state 341, the first member 310 locks the second member 320 in the second locked state, and the second member 320 in the second locked state would not engage with the third member 330 to release the third member 330. The first member 310 is operable to move to the first unlocked state 342 by a user, such that the second member 320 may be moved to the second unlocked state. When it is desired to disconnect the plug connector 10 from the socket connector 20, the first member 310 is first moved to the first unlocked state 342 (e.g., as shown in FIG. 6B), and then the second member 320 is moved to the second unlocked state (for example, is pressed to the right). Accordingly, the third member 330 is pressed against by the second member 320 and moved to the third unlocked state, and therefore, the plug connector 10 may be separated from the socket connector 20. This prevents the plug connector 10 from being accidentally removed from the socket connector 20 under complex conditions, such as vibration, impact, or entanglement from other cables.

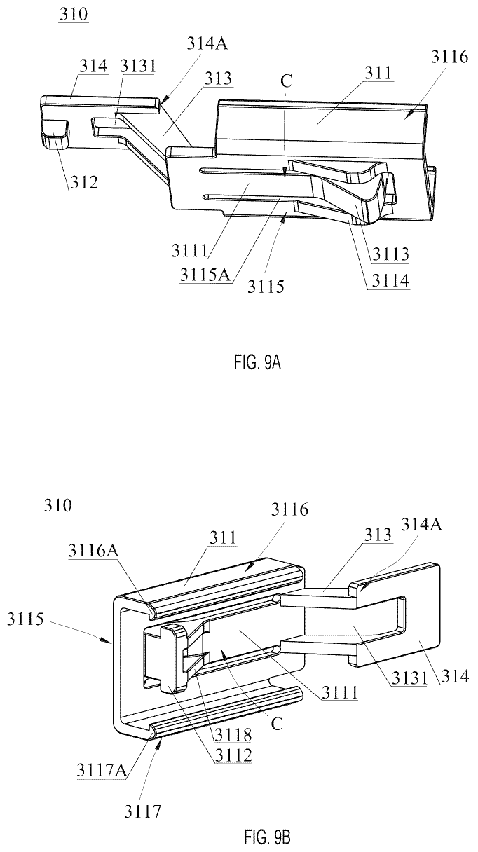

Exemplarily, as shown in FIGS. 2 and 9A to 9B, the first member 310 may include a first body 311 and a first locking part 312 for engaging with the second member 320. The first body 311 may include a first actuator C that is operable by a user. The first actuator C is operable such that the first member 310 may be moved between the first locked state 341 and the first unlocked state 342 along a first direction, enabling the first locking part 312 to move along the first direction. The first locking part 312 locks the second member 320 when the first member 310 is in the first locked state 341 and releases the second member 320 when the first member 310 is in the first unlocked state 342.

FIG. 6A shows the first member 310 in the first locked state 341, and FIG. 6B shows the first member 310 in the first unlocked state 342 to release the second member 320. As shown, the first direction may be parallel to the mating direction X-X. As shown in FIG. 6A, when the first member 310 is in the first locked state 341, the first locking part 312 of the first member 310 may abut against the second member 320 towards the outer side of the first housing 200, for example, abut against a rib 322 of the second member 320, thereby preventing the rib 322 from engaging with the third member 330. The third member 330 may be kept in its third locked state. When the first member 310 is moved to the first unlocked state 342 in the first direction by operating the first actuator C, as shown in FIG. 6B, the first locking part 312 of the first member 310 is staggered with the rib 322 of the second member 320. When a force is applied to the second member 320 in the first lateral direction Y-Y (for example, towards the right), the second member 320 may be moved to the second unlocked state and press against the third member 330, so that the third member 330 may be forced to the third unlocked state. For example, the first locking part 312 of the first member 310 may be engaged or disengaged with the second member 320 for locking or releasing the second member 320, respectively. The second member 320 is engaged with the first member 310 when in the second locked state, and is engaged with the third member 330 when in the second unlocked state. In other embodiments, the second member 320 may not include the rib, and the first locking part 312 of the first member 310 may also lock and unlock the second member 320 by abutting against any suitable part of the second member 320.

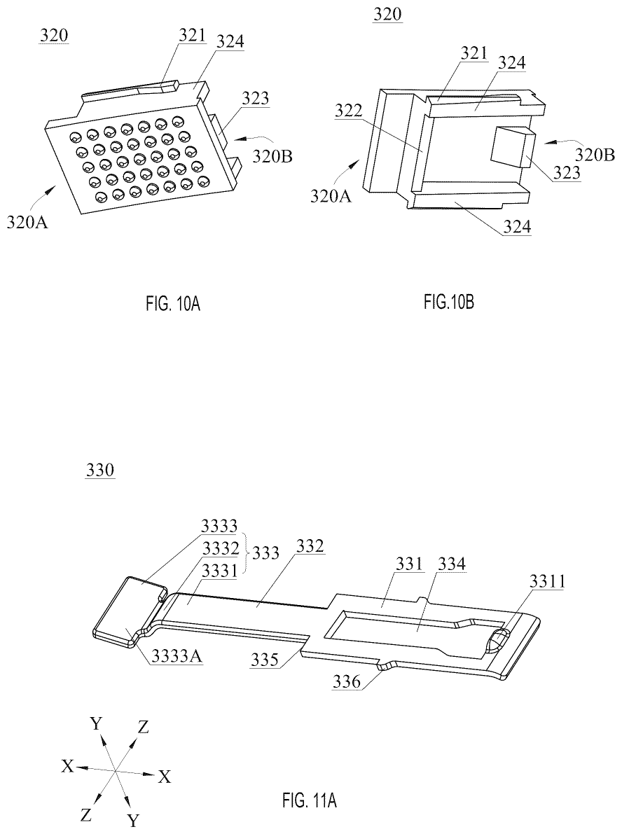

Exemplarily, as shown in FIG. 9A, the first member 310 may also include a first intermediate part 313 connected between the first locking part 312 and the first body 311. The first member 310 may include a first support part 314, and the first locking part 312 may protrude from the first support part 314. The first intermediate part 313 is connected between the first body 311 and the first support part 314. The rib 322 for engaging with the first locking part 312 of the first member 310 may be arranged at a front portion 320A of the second member 320, as shown in FIG. 10B, and a rear portion 320B of the second member 320 may abut against, for example, the first housing 200 and/or the first member 310. Along the mating direction X-X, the front portion 320A of the second member 320 faces towards the socket connector 20 and the rear portion 320B of the second member 320 is away from the socket connector 20. Exemplarily, the first intermediate part 313 of the first member 310 may abut against the rear portion 320B of the second member 320 towards the outer side of the first housing 200. When the first member 310 is in the first locked state 341, the first locking part 312 of the first member 310 also abuts against the second member 320 on the inner side, such that the third member 330 cannot be moved to the third unlocked state by the second member 320. When the first member 310 is moved in the first direction to the first unlocked state 342, the first locking part 312 and the first intermediate part 313 of the first member 310 no longer limit the rib 322 and the rear portion 320B of the second member 320, respectively. Accordingly, the second member 320 may be released. The second member 320 may integrally be moved towards the inner side of the first housing 200 under a force in the first lateral direction Y-Y and press the third member 330, such that the third member 330 is moved to the third unlocked state. Optionally, the rear portion 320B of the second member 320 may be substantially fixed by the first housing 200, in which case only the front portion 320A of the second member 320 may be pressed inwardly to the second unlocked state.

Along a direction towards the outer side of the first housing 200, the second member 320 may be limited by the first housing 200 from detaching from the first housing 200. The second member 320 is held between the first member 310 and the first housing 200.

Exemplarily, the first actuator C may be kept in its rest position by friction. When the first actuator C is in a rest position, the first member 310 is kept in the first locked state 341. When the first member 310 is desired to move to its first unlocked state 342, an external force may be applied to the first actuator C in the first direction to overcoming the friction. In this case, the first direction may be parallel to the mating direction X-X, the first lateral direction Y-Y, or any other direction between the mating direction X-X and the first lateral direction Y-Y, as long as the first locking part 312 of the first member 310 may no longer abut against the rib 322 of the second member 320. The friction described herein may be valued based on working environment of the plug connector 10, so as to avoid the first actuator C from accidentally overcoming the friction and moving.

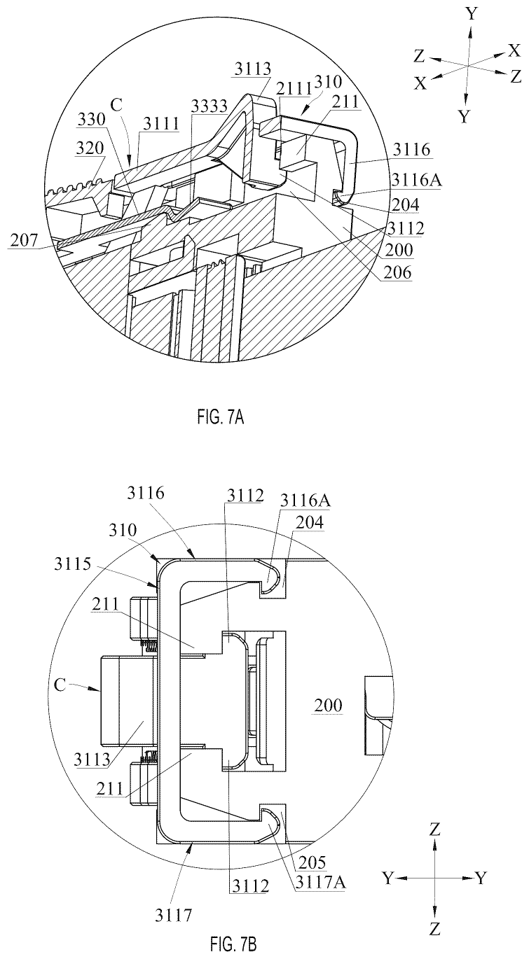

Exemplarily, the first actuator C is operable between the rest position (e.g., as shown in FIG. 7B) and a first actuated position (e.g., as shown in FIG. 7C) in a second direction. The second direction may be different from the first direction. Hereinafter, the principle of the present application is illustrated using the example of the first direction parallel to the mating direction X-X. When the first actuator C is in the rest position, a limiter 211 on the first housing 200 blocks the first actuator C along the first direction, such that the first member 310 is kept in the first locked state 341. Thus, the first member 310 is prevented from accidentally unlocking. Referring in conjunction to FIG. 6A and FIGS. 7A-7C, when the first member 310 is in the first locked state 341 and the first actuator C is not operated, a part of the first actuator C interferes with the limiter 211 on the first housing 200 to limit the first member 310 in the first locked state 341. When the first actuator C is subjected to an external force in the second direction (e.g., the first lateral direction Y-Y in the drawings), the first actuator C may be moved to the first actuated position towards the inner side of the first housing 200 so that the first housing 200 no longer blocks the interference part of the first actuator C.

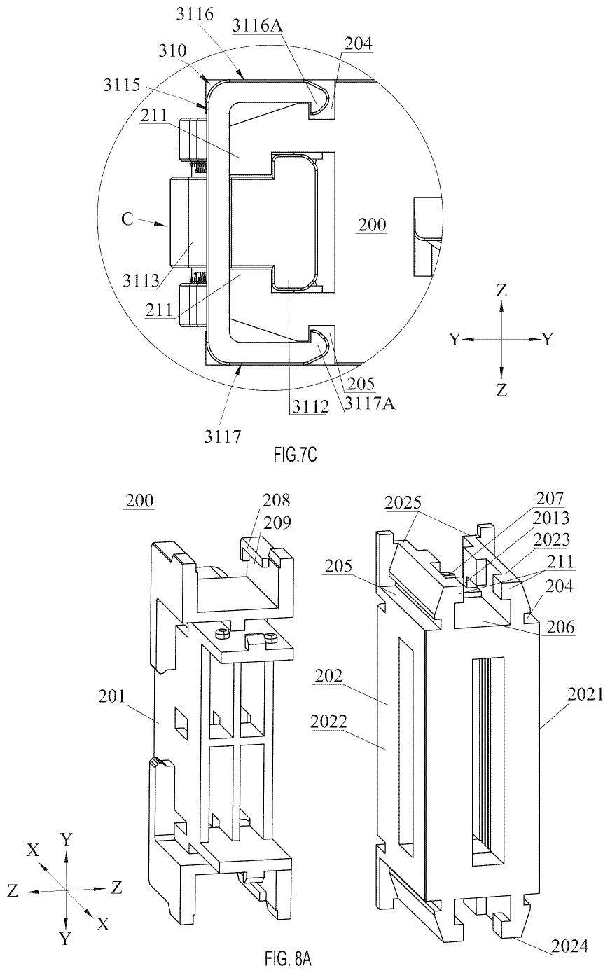

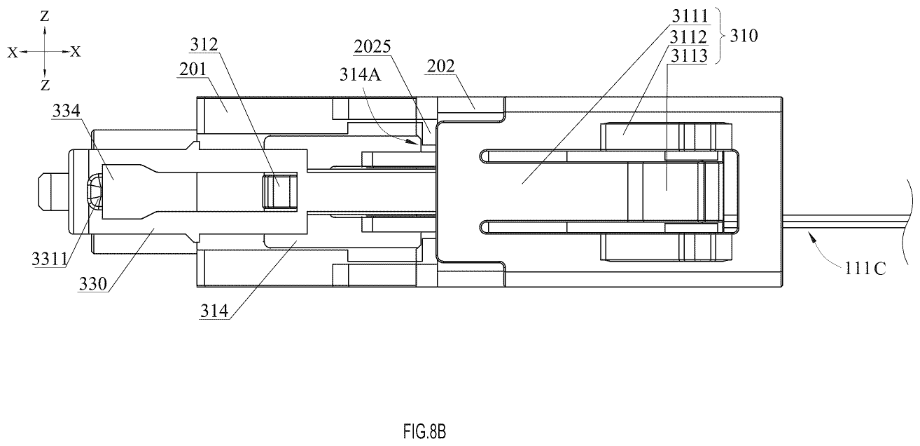

Exemplarily, the first housing 200 may include a mounting channel 206 extending along the first direction, such as the mating direction X-X (e.g., as shown in FIG. 8A). The first member 310 is movable in the mounting channel 206 between the first locked state and the first unlocked state in the first direction. The mounting channel 206 limits the movement range of the first member 310 in at least the first direction. The second member 320 and the third member 330 are also mounted to the mounting channel 206. The first actuator C has an inner portion accommodated within the mounting channel 206 and an outer portion extending beyond the mounting channel 206. The outer portion may be operated by the user. The limiter 211, such as a protrusion, may be arranged on a wall of the mounting channel 206. The limiter 211 may limit the first actuator C to the rest position, as shown in FIGS. 7A and 7B. Optionally, the limiter 211 may limit the first actuator C to the first actuated position. Exemplarily, the inner portion of the first actuator C may be in the shape of the Chinese character “ [symbol] ” viewed from the rear. When the first actuator C is in the first actuated position, the first actuator C is released by the limiter 211 and moved to a portion of the mounting channel 206 where the limiter 211 is located, as shown in FIG. 7C, so that the first member 310 may be moved to the first unlocked state 342 along the first direction (for example, the mating direction X-X). A first flange 2025 may be arranged on a wall of the mounting channel 206, and the first member 310 may comprise a second flange 314A, as shown in FIGS. 8A-8B and 9A-9B. When the first member 310 is in the first unlocked state 342, the first flange 2025 abuts against the second flange 314A. The width of the first support part 314 may be greater than the width of the first intermediate part 313 to form the second flange 314A. The first flange 2025 may protrude from the rear housing member 202 towards the inner of the mounting channel 206.

Exemplarily, the limiter 211 may include a protrusion with a short length in the first direction (for example, the mating direction X-X). During the movement of the first member 310 from the rest position to the first unlocked state 342, the first actuator C may step across the limiter 211. When the external force is no longer applied to the first actuator C, the first actuator C may restore to the rest position under its own or external elastic force. Therefore, the first actuator C may be limited again by the limiter 211 such that the first member 310 is in the first unlocked state 342, unless the first actuator C is operated to step across the limiter 211 again along a direction opposite to the unlocking direction, enabling the first member 310 to return to the first locked state 341.

Exemplarily, the limiter 211 may have a longer length in the first direction (for example, the mating direction X-X). The first actuator C abuts against an end 2111 of the limiter 211 when in the rest position, as shown in FIG. 7A. The first actuator C may climb onto the end 2111 of the limiter 211 and slide along the limiter 211 when in the first actuated position, such that the first member 310 may be moved to the first unlocked state 342. Exemplarily, the length of the limiter 211 along the mating direction X-X may not be less than the distance between the first locked state 341 and the first unlocked state 342. The limiter 211 may be in the shape of an elongated strip. In the unlocking process that the first member 310 is moved from the first locked state 341 to the first unlocked state 342, for example, along the pull-out direction in the mating direction X-X, the first actuator C first climbs onto the end 2111 of the limiter 211 and then keeps sliding against the surface of the limiter 211. In this way, when the first member 310 is in the first unlocked state 342, the first actuator C remains in the first actuated position. This allows a user to push the first member 310 directly from the first unlocked state 342 back to the first locked state 341 along the insertion direction in the mating direction X-X, without having to apply pressure to the first actuator C again, to restore the plug connector 10 to its initial state. In the embodiments not shown, the width of the limiter may be gradually decreased in the unlocking direction of the first member 310, such that the surface of the limiter 211 against which the first actuator C slides is inclined. The first actuator C may be in any position between the rest position and the first actuated position by sliding against the inclined surface of the limiter. When the first member 310 is located at the first unlocked state 342, the first actuator C may stop at an end of the limiter with a smaller size. When the first member 310 is moved from the first unlocked state 342 towards the first locked state 341, the first actuator C may be guided by the inclined surface of the limiter. When the first actuator C is moved to an end of the limiter with a larger size, the first actuator C is in the first actuated position. The first member 310 is re-limited to the first locked state 341 after the first actuator C crosses over the larger end of the limiter. In short, the limiter 211 may be configured reasonably to simplify the insertion and pulling-out of the plug connector 10. The user's experience can be improved.

Optionally, the first housing 200 may also comprise another limiter to block the first member 310 when the first member 310 is moved to the first unlocked state 342, such that the first member 310 is prevented from pulling off the first housing 200 under an excessive force from a user.

Exemplarily, the first actuator C may include a cantilever 3111 and a pair of wings 3112. The pair of wings 3112 protrude from two sides of a free end of the cantilever 3111, respectively. There may be a pair of limiters 211 for blocking a pair of wings 3112 in the first direction, respectively. In the embodiments as shown in FIGS. 9A and 9B, the cantilever 3111 may be integrally molded with the first member 310. In this case, the first member 310 may be molded with insulating materials, such as plastics. Plastics may include but be not limited to liquid crystal polymers (LCP), polyphenylene sulfite (PPS), high-temperature nylon or poly-p-phenylene oxide (PPO), or polypropylene (PP), or other materials may be used. In some cases, plastics may be thermosetting plastics. In some cases, plastics may include fiberglass-reinforced material. In some embodiments, the cantilever 3111 may be connected to the first member 310 by any suitable way, such as bonding, after they are separately manufactured. The pair of wings 3112 may be opposite to each other in the second lateral direction Z-Z. The pair of wings 3112 may cooperate with the pair of limiters 211 of the first housing 200, respectively. Referring in conjunction to FIGS. 6A-6B and 7A-7C, when the first member 310 is in the first locked state 341, the pair of wings 3112 are limited by the limiters 211, respectively. Exemplarily, strengthening portions 3118 may connect the wings 3112 to the cantilever 3111 for protecting wings 3112 (e.g., as shown in FIG. 9B). The cantilever 3111 is elastic to allow the free end thereof to move in a small amplitude, such that the wings 3112 may move in the first lateral direction Y-Y. When subjected to an external force in the first lateral direction Y-Y, wings 3112 may move towards the interior of the first housing 200 to climb onto the limiter 211. When the external force applied to the first actuator C is withdrawn, the wings 3112 may return to their rest positions under the elasticity of cantilever 3111. For example, the free end of the cantilever 3111 may be restored to its original state based on an external elastic member. The first actuator C in the form of cantilever 3111 has simpler structure and may be processed efficiently. The force on each wing 3112 may be reduced by utilizing the pair of limiters 211 to cooperate with the pair of wings 3112, respectively. Thus, the first member 310 is reliably held in its first locked state. For example, when the first actuator C does not reach the first actuated position and the first member 310 is accidentally pulled, the wings 3112 are uneasily to be broken.

Exemplarily, an outer surface of the first actuator C has a projection 3113 projecting beyond an outer surface of the first body 311. The outer surface of the first body 311 comprises protruding protectors 3114 around the projection 3113. Continuing to refer to FIGS. 2 and 7A-7C, a user may press the free end of the cantilever 3111 of the first actuator C, such that the first actuator C may reach the first actuated position (e.g., as shown in FIG. 7C) under a less force. The projection 3113 may be arranged at the free end of the cantilever 3111, so that the user may easily press the first actuator C. In other embodiments, the projection 3113 may be arranged at any other location near the free end of the cantilever 3111. As shown in FIG. 2, in order to prevent the cantilever 3111 and projection 3113 from breaking due to an external force in use, the protectors 3114 are provided. The protectors 3114 may be in a similar shape to the projection 3113. The projection 3113 and the cantilever 3111 may be protected by the protectors 3114 to a certain extent when the plug connector 10 is impacted. The protectors 3114 may also prevent the user from further downward pressing the projection 3113 after the first actuator C is pressed to the first actuated position, to prevent the first actuator C from scraping the first housing 200 and/or prevent the cantilever 3111 from over-bending, even breaking off. The protectors 3114 also prevent the free end of the cantilever 3111 from being mis-operated to a certain extent.

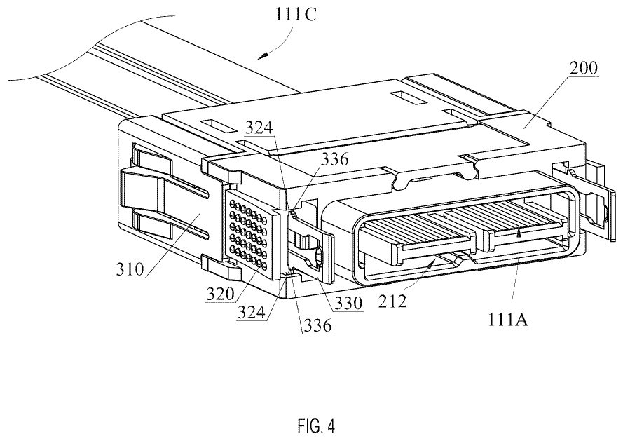

Exemplarily, referring in conjunction to FIGS. 4, 10A, 10B and 11A, the third member 330 may also include protruding third limiters 336. The second member 320 abuts against the third limiters 336 in the pull-out direction of the plug connector 10 from the socket connector 20 to prevent the third member 330 from retracting into the first housing 200. Exemplarily, the third limiters 336 may be arranged on opposite sides of the third member 330 along the second lateral direction Z-Z. A rib 322 may be connected between a pair of side walls 324, and the side walls 324 may protrude beyond the rib 322 towards the interior of the first housing 200. The third member 330 may be located between the pair of side walls 324 to limit the third member 330 in the second lateral direction Z-Z. Also, in the pull-out direction of the plug connector 10, the pair of side walls 324 may abut against the third limiters 336. Thus, during the insertion of the plug connector 10 into the socket connector 20, the third member 330 cannot retract into the first housing 200 under a friction from the socket connector 20. The plug connector 10 may be locked to the socket connector 20 reliably.

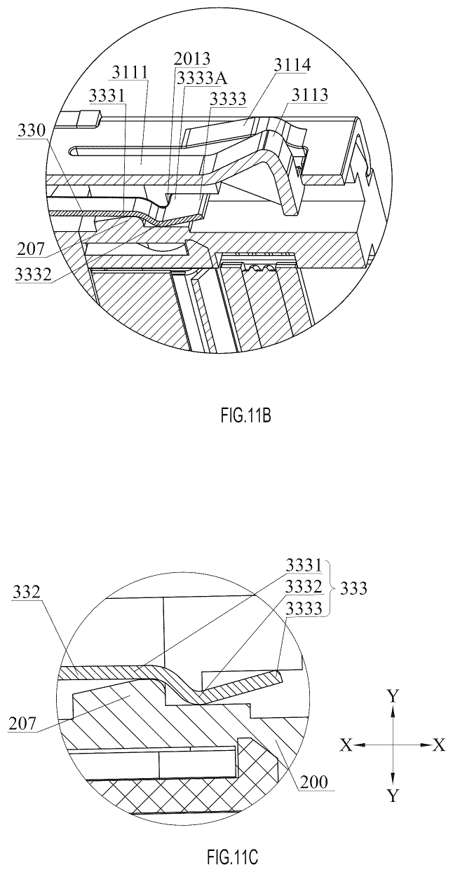

Exemplarily, the third member 330 may be held in place by the second member 320 and the first housing 200 along the mating direction X-X. Referring in conjunction to FIGS. 1 and 11A, the third member 330 may include a third locking part 331 and a third tail 333. The third locking part 331 and the third tail 333 are located at opposite ends of the third member 330 respectively. The third locking part 331 may lock and release the socket connector 20. Exemplarily, the third locking part 331 may include a barb 3311. The third locking part 331 may be biased outwardly so that the barb 3311 on the third locking part 331 may be engaged with the connector locking portion 610 of the socket connector 20. During the insertion of the plug connector 10 into the socket connector 20, the barb 3311 may slide along the inner surface of the socket connector 20. After the plug connector 10 is inserted in place, the barb 3311 may be engaged with the connector locking portion 610 of the socket connector 20 to prevent accidental disconnection of the plug connector 10 and the socket connector 20. When the third locking part 331 is pressed towards the interior of the first housing 200, the barb 3311 may be disengaged with the connector locking portion 610 of the socket connector 20 so that the plug connector 10 may be separated from the socket connector 20.

The third member 330 may also include a third intermediate part 332 connected between the third locking part 331 and the third tail 333. The width of the third intermediate part 332 is smaller than the width of the third locking part 331, so that steps 335 may be formed. In addition, the width of the third intermediate part 332 is less than the width of at least part of the third tail 333. As to be described later, the at least part of the third tail 333 may limit the position of the third member 330 in a direction toward the socket connector 20. The steps 335 may limit the position of the third member 330 in a direction away from the socket connector 20. The steps 335 cooperate with the at least part of the third tail 333 to fix the third member 330 onto the first housing 200. Referring to FIGS. 9A and 9B, the first intermediate part 313 of the first member 310 may include a gap 3131, and the third intermediate part 332 may pass through the gap 3131. The first locking part 312 of the first member 310 is configured to engage with the second member 320 outwards on the inner side of the third member 330, as shown in FIG. 6A, and thus the first support part 314 with the first locking part 312 is located on the inner side of the third member 330. The first body 311 of the first member 310 includes the first actuator C which needs to be operated by a user, and thus the first body 311 is configured to be located on the outer surface of the first housing 200. The first body 311 may be on the outer side of the third member 330. Based on this, the third member 330 passes through the gap 3131 in the first member 310, such that the first member 310 and the third member 330 are crossed. Exemplarily, the width of the third intermediate part 332 may be adapted to the width of the gap 3131 such that the first intermediate part 313 may also limit the position of the third member 330 along the second lateral direction Z-Z. For example, the third intermediate part 332 of the third member 330 may be slightly narrower than the gap 3131 of the first intermediate part 313. The widths of the third locking part 331 of the third member 330 and the at least part of the third tail 333 may be greater than the width of the third intermediate part 332 as well as the width of the gap 3131 of the first intermediate part 313. Thus, the third member 330 may be installed onto the first intermediate part 313 through the gap 3131.

Exemplarily, the first intermediate part 313 may include a pair of beams, each of which is connected between the first locking part 312 and the first body 311, respectively. The pair of beams are spaced apart along the second lateral direction Z-Z perpendicular to the mating direction X-X to form the gap 3131. In this case, the rear portion 320B of the second member 320 may comprise a spacer 323. A pair of slits may be formed between the spacer 323 and the pair of side walls 324. The pair of slits are located on two sides of the spacer 323, respectively, as shown in FIG. 10B. The pair of beams of the first intermediate part 313 may be inserted into the pair of slits, respectively. Accordingly, the first member 310 and the second member 320 may be guided by each other, to provide precise positioning.

Exemplarily, the gap 3131 may extend into the first support part 314 to enlarge the length of the gap 3131. Exemplarily, the gap 3131 may not extend into the first body 311, enabling the first body 311 to be smooth on the outer side of the first housing 200. The longer gap 3131 allows the wider third locking part 331 and/or third tail 333 of the third member 330 to pass through. Before the third member 330 and the first member 310 are installed onto the first housing 200, the third member 330 may be erected and passed through the gap 3131, and then rotated 90 degrees relative to the first member 310 to create an X-shaped structure. Regardless of whether the gap 3131 extends to the first support part 314, the front of the first support part 314 is solid and the first locking part 312 may be arranged on the front of the first support part 314. The first locking part 312 may pass through a third opening 334 in the third member 330 to engage with the second member 320. The mechanical strength of the third member 330 may be unaffected by arranging the third opening 334 in the middle of the third member 330, and the first locking part 312 may be positioned on the solid front of the first support part 314 to align in position with the third opening 334.

Exemplarily, the third member 330 may be made of a metal sheet. Therefore, the third member 330 may be configured to have both sufficient mechanical strength and a certain degree of elasticity. The third member 330 is elastically deformable between the third locked state and the third unlocked state. Exemplarily, the third member 330 may be substantially flat, without any large bend and protrusion, such that the third member 330 may smoothly pass through the gap 3131 of the first intermediate part 313. In this way, the plug connector 10 may be smaller along the first lateral direction Y-Y. In contrast, the first member 310 is relatively complex in structure and is preferably molded by an injection molding process to ensure accuracy and reduce costs.

Exemplarily, the second member 320 may be configured to be pressed into the second unlocked state towards the interior of the first housing 200. Both the second member 320 and the first body 311 of the first member 310 may be operated by a user to actuate the third member 330. A portion of the third member 330 with a barb 3311 may stretch out of the first housing 200, to lock the socket connector 20. As described herein, the first locking part 312 may be located on the inner side of the second member 320 to abut against the second member 320 towards the outer side of the first housing 200 when the first member 310 is in the first locked state 341, such that the second member 320 is kept in the second locked state. It is more in line with the user habits to unlock the plug connector 10 by pressing and then separate the plug connector 10 from the socket connector 20 by applying a force in the mating direction X-X. Exemplarily, the second member 320 is designed to reach the second unlocked state when subjected to a pressure towards the first housing 200. The first locking part 312 of the first member 310 abuts against the second member 320 when the first member 310 does not reach the first unlocked state 342, such that the second member 320 cannot be pressed into the second unlocked state. If the second member 320 is pressed, the pressure applied on the first locking part 312 may also be transmitted to the first housing 200, so as to avoid damage to the first member 310.

Based on the above description, the first direction parallel to the mating direction X-X has advantages that a space in the first housing 200 along the mating direction X-X may allow for the movement of the first member 310, and a space in the first housing 200 along the first lateral direction Y-Y may allow for the movement of the second member 320. The plug connector 10 may be unlocked from the socket connector 20 by pressing the second member 320 along the first lateral direction Y-Y. It aligns better with user habits and is more convenient to pull out the plug connector 10 while pressing the second member 320.

Exemplarily, continuing with FIGS. 6A and 6B, the third opening 334 in the third member 330 may extend in the first direction (such as the mating direction X-X), and the first locking part 312 may be engaged with the second member 320 through the third opening 334. When the first member 310 moves between the first locked state 341 and the first unlocked state 342, the first locking part 312 slides in the third opening 334. The second member 320 in the second unlocked state may apply pressure to the third member 330 so that the third member 330 reaches the third unlocked state. Therefore, the first locking part 312 may prevent the second member 320 from exerting inward pressure on the third member 330 when the first member 310 is in the first locked state 341. Moreover, when the first member 310 is in the first unlocked state 342, the second member 320 is allowed to apply pressure onto the third member 330, such that the third member 330 may move to the third unlocked state. As shown, the first locking part 312 may, exemplarily, abut against the second member 320 when the first member 310 is located at the first locked state 341; and the first locking part 312 no longer abuts against the second member 320 when the first member 310 is located at the first unlocked state 342. The first locking part 312 is not in contact with the third member 330, so that the movement of the third member 330 is unrestricted. In a preferred embodiment, the third member 330 comprises the third opening 334, and the first locking part 312 is removable in the third opening 334 of the third member 330. In this way, the third member 330 may not interfere with the first member 310, and the second member 320 may be unaffectedly engaged with the third member 330. When the first member 310 is in the first locked state 341, the second member 320 may abut against the first locking part 312, and the third member 330 can be locked.

For example, in an exemplary embodiment, the first locking part 312 may pass through the third opening 334 and protrude beyond an outer side surface of the third member 330, such that the second member 320 is prevented from contacting the third member 330 when the first member 310 is in the first locked state 341, even if the second member 320 is pressed. In another exemplary embodiment, the protruding end of the first locking part 312 may be flush with the outer side surface of the third member 330. When the first member 310 is in the first locked state 341 and the second member 320 is pressed, although the second member 320 is in contact with the third member 330, the third member 330 may barely move to unlock the third locking part 331. In short, the first locking part 312 abuts against the second member 320 when the first member 310 is in the first locked state 341, so that even if an external force is applied onto the second member 320, the third locking part 331 cannot be unlocked and the plug connector 10 cannot accidentally separate from the socket connector 20.

Exemplarily, as shown in FIGS. 9A to 9B, the first body 311 may also include a first wall 3115. The first actuator C may be arranged on the first wall 3115. Exemplarily, the first wall 3115 may also include a first opening 3115A. The first actuator C is connected to an edge of the first opening 3115A. The first actuator C may be in the form of the cantilever 3111, with one end connected to the edge of the first opening 3115A and the other end being free. The free end of cantilever 3111 extends towards an opposite edge of the first opening 3115A. The projection 3113 on the cantilever 3111 may protrude out of the first opening 3115A towards the outer side of the first housing 200. The wings 3112 on the cantilever 3111 may protrude out of the first opening 3115A towards the inner side of the first housing 200. The first body 311 may also include a second wall 3116 and a third wall 3117, and the second wall 3116 and the third wall 3117 may be arranged on opposite sides of the first wall 3115 along a direction perpendicular to the first direction (such as the mating direction X-X). Thus, the first body 311 may be on three sides of the first housing 200, thereby increasing the connection strength. The second wall 3116 and the third wall 3117 may include a first snapping portion 3116A and a second snapping portion 3117A, respectively. The first snapping portion 3116A and the second snapping portion 3117A are slidably connected to the first housing 200 along the mating direction X-X. The first snapping portion 3116A and the second snapping portion 3117A are snapped to the first housing 200 in a direction perpendicular to the first direction. Referring in conjunction to FIGS. 7A to 7C and 9A to 9B, the second wall 3116 and the third wall 3117 may be roughly flush with the outer surface of the first housing 200, such that the outer surface of the plug connector 10 is smooth. The first snapping portion 3116A and the second snapping portion 3117A may be protrusions which extend along the mating direction X-X and protrude toward each other. The first housing 200 has a first side surface 2021 and a second side surface 2022 opposite along the second lateral direction Z-Z as well as a third side surface 2023 and a fourth side surface 2024 opposite along the first lateral direction Y-Y. The first side surface 2021 and the second side surface 2022 may be arranged with a first slot 204 and a second slot 205, respectively. The first slot 204 and the second slot 205 extend along the mating direction X-X and are engaged with the first snapping portion 3116A and the second snapping portion 3117A, respectively, such that the first member 310 may not only be installed onto the first housing 200, but also be slidable on the first housing 200 along the mating direction X-X. Exemplarily, the first member 310 may be snapped onto the first housing 200 along the first lateral direction Y-Y. A portion (e.g., an upper portion in FIG. 8A) of the first side surface 2021 between the third side surface 2023 and the first slot 204 may be oblique, to facilitate installation of the first member 310. Similarly, a portion of the second side surface 2022 between the third side surface 2023 and the first slot 204 may be oblique. Therefore, when the first member 310 is installed onto the first housing 200 along the first lateral direction Y-Y, the first snapping portion 3116A and the second snapping portion 3117A of the first member 310 may slide along the oblique portions of the first side surface 2021 and the second side surface 2022, respectively, and the oblique portions force the second wall 3116 and the third wall 3117 to deform. After the first snapping portion 3116A and the second snapping portion 3117A are engaged to the first slot 204 and the second slot 205 respectively, the second wall 3116 and the third wall 3117 are restored. Therefore, the first member 310 may only move along the mating direction X-X. It should be noted that before the first member 310 is ready to be installed onto the first housing 200, the wings 3112 of the first member 310 are staggered with respect to the limiter 211 along the mating direction X-X, such that wings 3112 and limiters 211 may be avoided from damaging by external forces.

As shown in FIG. 10B, the first housing 200 may include a front housing member 201 and a rear housing member 202. In this embodiment, the first member 310 is connected to the rear housing member 202, so that the first slot 204 and the second slot 205 may be arranged in the rear housing member 202. For example, optionally, the first slot 204 and the second slot 205 may also extend to the front housing member 201 to increase the slidable range of the first member 310. The front housing member 201 is closer to the socket connector 20 than the rear housing member 202. The first mating portion 11 is formed by the front housing member 201, and the first tail portion 12 is formed by the rear housing member 202. The plurality of contact pads 113 may extend into the front housing member 201. Optionally, the first housing 200 may also be a one-piece member.

Exemplarily, along the mating direction X-X of the plug connector 10 to the socket connector 20, the second member 320 is limited between the first housing 200 (such as, front housing member 201) and the first member 310, or between the front housing member 201 and the rear housing member 202, or a combination of the two. Referring in conjunction to FIG. 8A and FIG. 10A to FIG. 10B, flanges 321 may be arranged on the pair of side walls 324 of the second member 320 respectively, and the front housing member 201 may include blocking portions 208. Exemplarily, the blocking portions 208 may be L-shaped. In case that the second member 320 may be installed to the front housing member 201 from the rear, the blocking portions 208 each may include a first edge substantially parallel to the mating direction X-X and a second edge substantially perpendicular to the first edge. The second edge may block the flange 321 of the second member 320, such that the second member 320 cannot be divorced from the plug connector 10 along the mating direction X-X. When the first member 310 is in the first locked state 341, the rear end of the second member 320 may abut against the first intermediate part 313 or the first body 311 of the first member 310, or abut against the rear housing member 202, such that the second member 320 cannot move in the mating direction X-X.

Exemplarily, along the first lateral direction Y-Y perpendicular to the mating direction X-X, the second member 320 is confined by the first housing 200 and the first member 310. The L-shaped blocking portions 208 may enclose cavities 209, and the flanges 321 of the second member 320 are inserted into the cavities 209. Thus, the blocking portions 208 may limit the motion of the second member 320 along the first lateral direction Y-Y to prevent the second member 320 from separating from the first housing 200.

Since the plug connector 10 needs to be mated to the socket connector 20 along the mating direction X-X, for such a flat plug connector 10, the second member 320 to be operated is arranged in the lateral direction to avoid structural interference, or avoid from hindering the mating of the plug connector 10 to socket connector 20. Exemplarily, for a plug connector 10 with a cable such as a flexible flat cable (FFC) 111, the size of the plug connector 10 in the second lateral direction Z-Z is generally smaller than that in the first lateral direction Y-Y. Therefore, the second member 320 is arranged between the first housing 200 and the first member 310 along the first lateral direction Y-Y, such that the space in the plug connector 10 may be effectively used and the design is simplified.

Next, the assembly of the third member 330 is described. In some embodiments, as shown in FIGS. 11A to 11C, the third tail 333 and the third locking part 331 of the third member 330 are arranged at opposite ends of the third member 330 along the mating direction X-X. As described herein, the third tail 333 and the third locking part 331 are jointed by the third intermediate part 332, such that the third member 330 is a slender one-piece member. The third tail 333 may be fixed to the first housing 200. The slender third member 330 improves the elasticity of the end where the third locking part 331 is located, thereby the third locking part 331 can smoothly move along the first lateral direction Y-Y to lock and unlock the socket connector 20. However, it may cause the third member 330 to sway along the second lateral direction Z-Z. Therefore, the third intermediate part 332 is configured to pass through the gap 3131 in the first member 310, such that the intermediate part 332 of the third member 330 may be limited along the second lateral direction Z-Z. In this way, the third locking part 331 may be aligned and locked with the connector locking portion of the socket connector 20.

The third tail 333 can, exemplarily, not only fix the third member 330 to the first housing 200, but also offset the third locking part 331 towards a direction for locking the socket connector 20. For example, the third tail 333 includes a connecting portion 3331, an intermediate portion 3332 and an end portion 3333 connected successively along the mating direction X-X. The connecting portion 3331 may be connected to the third locking part 331 via the third intermediate part 332. The intermediate portion 3332 may be bent towards the interior of the first housing 200 (e.g., downwards as shown in FIGS. 11B to 11C) and abut against the first housing 200. The end portion 3333 is oriented towards the exterior of the first housing 200 (e.g., upwards) and abuts against the first housing 200. The first housing 200 may comprise a fulcrum 207, such as, a projection in a channel 206 in the first housing 200, as shown in FIGS. 7A and 8A. The connecting portion 3331 of the third tail 333 may be biased by the fulcrum 207 towards the exterior of the first housing 200. Referring in conjunction to FIGS. 11A to 11C, the third member 330 may be fixed at the third tail 333, and the third member 330 is configured with elasticity, which allows the third locking part 331 to be applied a biased force outwards. In this way, the third member 330 may be kept in the third locked state by means of its own elasticity. When the second member 320 is pressed inwards, the third member 330 may move from the third locked state to the third unlocked state, such that the plug connector 10 is unlocked with the socket connector 20. Since the connecting portion 3331 of the third tail 333 abuts against the fulcrum 207 of the first housing 200, the third locking part 331 of the third member 330 is biased outwards due to lever effect when the intermediate portion 3332 and the end portion 3333 of the third tail 333 are subjected to an inward force. In addition, the intermediate portion 3332 is bent towards the interior of the first housing 200 and abuts against the fulcrum 207 in the mating direction X-X. When the third member 330 is subjected to a tension towards the socket connector 20, the intermediate portion 3332 may be stuck by the fulcrum 207 to prevent the third member 330 from being pulled out. This further avoids loosening or separation of the plug connector 10 from the socket connector 20. Further, the intermediate portion 3332 and the connecting portion 3331 is pressured by the first housing 200 towards the outer side, while the end portion 3333 of the third tail 333 is pressured towards the inner side. It is also possible to fix the third tail 333 of the third member 330 to the first housing 200.

Exemplarily, the end portion 3333 of the third tail 333 may be arranged with a third wing 3333A on each side. In a direction of the plug connector 10 inserted into the socket connector 20, the third wings 3333A abut against the first housing 200. The third wings 3333A may protrude from the third tail 333 in the second lateral direction Z-Z. A pair of stops 2013 may be arranged in the first housing 200. The pair of stops 2013 may limit the pair of third wings 3333A respectively to prevent the third member 330 from breaking away from the first housing 200.

Exemplarily, in the case of the first housing 200 comprising a front housing member 201 and a rear housing member 202, the first member 310 is installed onto the rear housing member 202 and extends into the front housing member 201. The second member 320 is installed between the front housing member 201 and a portion of the first member 310 extending into the front housing member 201, and the third member 330 is installed into the rear housing member 202 and extending into the front housing member 201. With reference to FIG. 5, as described herein, the first member 310 is installed to the first housing 200 in the first lateral direction Y-Y. The third member 330 needs to pass through the gap of the first intermediate part 313 and be installed to the first housing 200, with the third wings 3333A of the third tail 333 engaged with the first housing 200 and the connecting portion 3331 of the third tail 333 abutting against the first housing 200. If the first housing 200 is processed integrally, it may be difficult for the first member 310, the second member 320 and the third member 330 to be assembled to the first housing 200. The assembling difficulty may be reduced by separately manufacturing the front housing member 201 and the rear housing member 202 by injection molding. After the first member 310, the second member 320 and the third member 330 are installed to the front housing member 201 and the rear housing member 202 respectively, the front housing member 201 and the rear housing member 202 may be assembled together. In this way, the first member 310, the second member 320 and the third member 330 can be mounted to the first housing 200 in place. Exemplarily, the second member 320 is limited by the first housing 200. The second member 320 is installed to the front housing member 201 from the rear side, and then the rear housing member 202 is assembled to the front housing member 201, such that the second member 320 is limited in position by the rear housing member 202. In this way, the structure is simpler and the costs are lower.

The first conducting assembly 100 may be fixed to the first housing 200 by the TPA device 350, as shown in FIGS. 5 and 13. After the first conducting assembly 100 is inserted into the first housing 200, the TPA device 350 may be installed into the first housing 200. The TPA device 350 may include a first locking member 351. The first locking member 351 has a first holding position and a first releasing position. When the first locking member 351 is in the first holding position, the first conducting assembly 100 is clamped between the first housing 200 and the first locking member 351. The first conducting assembly 100 is detachable from the first housing 200 when the first locking member 351 is in the first releasing position. Exemplarily, a strain relief component 3511 may be fixed to the first locking member 351. When the first locking member 351 is in the first holding position, the strain relief component 3511 may be clamped between the first conducting assembly 100 and the first locking member 351.

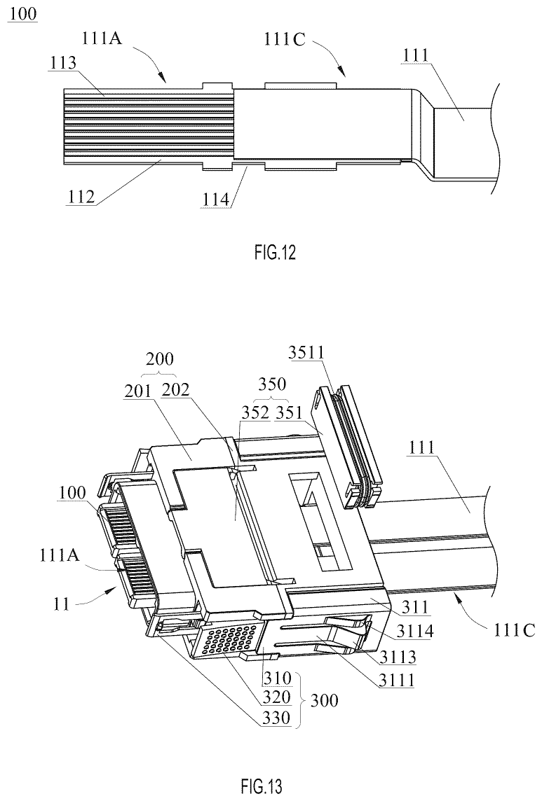

As described herein, the plug connector 10 may, exemplarily, be a cable connector. As shown in FIG. 12, the first conducting assembly 100 may include at least one flexible flat cable (FFC) 111. Each flexible flat cable 111 may include a mating contact end, a mounting end and an interconnecting portion. As shown in FIG. 12, each flexible flat cable 111 may be include a plurality of conductors, and insulating layers covering the upper and lower sides of the conductors respectively. The insulating layers may have good flexibility and insulating properties, as well as high tensile strength. A portion of the insulating layer on a side of an end of the flexible flat cable 111 (such as on the upper side in the drawings) is removed, or a shorter upper insulating layer is selected in the manufacture of the flexible flat cable 111 to expose ends of the conductors, thereby forming the plurality of contact pads 113. The end with the plurality of contact pads 113 may be referred to as the mating contact end 111A. The mating contact end 111A may extend into the first housing 200. As shown in FIG. 4, the first housing 200 may include a slot 212. The slot 212 may be configured to receive the mating socket connector 20. The slot 212 may be elongated along the first lateral direction Y-Y. The mating contact end 111A may be extended into the slot 212. Optionally, the first housing 200 may not include the slot 212 and the mating contact end 111A may be simply inserted into the socket connector 20. The other end of the flexible flat cable 111 may be installed to any suitable electrical component, such as a circuit board, an electronic device, or another electrical connector, so it is referred to as the mounting end 111B, as shown in FIG. 1. The mounting end 111B is outside the first housing 200. The mounting end 111B may have similar construction to the mating contact end 111A. The interconnecting portion 111C is connected between the mating contact end 111A and the mounting end 111B.

In the illustrated example, mating contact ends 111A of flexible flat cables 111 have a first surface and a second surface. The first surface and the second surface are opposite in the second lateral direction Z-Z. Each of the first surface and the second surface includes a plurality of contact pads 113. The contact pads 113 on each surface may be arranged in a row parallel to the first lateral direction Y-Y. The contact pads 113 are electrically connected to the second terminals 400 of the socket connector 20 respectively. As a result, a high-density cable connector is provided. Exemplarily, the insulating layers on both sides of the mating contact end 111A of each flexible flat cable 111 may be removed to form a first surface and a second surface. If there are multiple flexible flat cables 111, they may be arranged along the first lateral direction Y-Y.

Exemplarily, the connector may include a first flexible flat cable and a second flexible flat cable. The first flexible flat cable and the second flexible flat cable may be stacked along the second lateral direction Z-Z. The mating contact end of the first flexible flat cable may comprise the first surface described herein. Based on this, the mating contact end of the first flexible flat cable also has a third surface, which is opposite to the first surface in the second lateral direction Z-Z. The mating contact end of the second flexible flat cable may comprise the second surface described herein. Based on this, the mating contact end of the second flexible flat cable also has a fourth surface, which is opposite to the second surface in the second lateral direction. Thus, the third surface and the fourth surface face each other and are attached to the first housing 200. The third surface and the fourth surface may include insulating layers and be attached to a reinforcing plate 112 to enhance the mechanical strength of the mating contact end 111A. Exemplarily, the third surface and the fourth surface are attached to respective reinforcing plates 112. Each reinforcing plate 112 is fixed to the first housing 200. For example, portions of the conductors of the flexible flat cable 111 on the reinforcing plate 112 may be unnecessary to be fully exposed in the length direction of the flexible flat cable 111. The exposed portions are mainly used for electrical connection with the mating socket connector 20. For example, a portion of the upper insulating layer can be retained on the reinforcing plate 112, such that the mechanical strength of the first conducting assembly 100 may be increases and the service life can be lengthened. Optionally, a plurality of contact pads 113 may be formed on the reinforcing plate 112 by printing, engraving, etc., and the conductors of the flexible flat cable 111 are electrically connected to the contact pads 113 respectively. The reinforcing plate 112 may be of high structural strength and the flexible flat cable 111 may be fixed in the plug connector 10 by the reinforcing plate 112.

In the embodiment that there are a plurality of first flexible flat cables and a plurality of second flexible flat cables, the plurality of first flexible flat cables may be arranged along the first lateral direction Y-Y, and the plurality of second flexible flat cables may also be arranged along the first lateral direction Y-Y. For example, there may also be only one first flexible flat cable and one second flexible flat cable.

As shown in FIG. 5, the first housing 200 may comprise a guide slot 203, which may be configured to limit and guide the reinforcing plate 112 of the mating contact end 111A. This avoids the mating contact end 111A from skewing with respect to the first housing 200. The reinforcing plate 112 may be inserted in the plug connector 10 in place, under the limit of the guide slot 203. The first conducting assembly 100 is then fixed to the first housing 200 by the TPA device 350. The first conducting assembly 100 is detachably connected to the plug connector 10. The first conducting assembly 100, such as the flexible flat cable 111, may be broken or damaged, resulting in an interruption of the line connection. Or, the contact pads 113 are corroded, contaminated or worn in long-time use, resulting in poor contact. For example, when the plug connector 10 cannot continue to operate normally due to the first conducting assembly 100, the first conducting assembly 100 may be detached from the plug connector 10. The costs may be lower by replacing only the first conducting assembly 100. Also, the assembly process may be simplified and the structure may be simple by using the first locking member 351 to clamp the first conducting assembly 100.

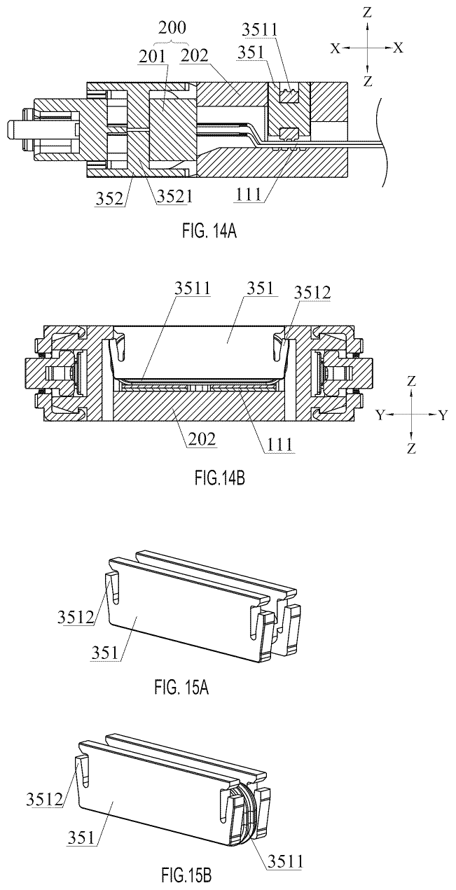

Exemplarily, the first locking member 351 is detachably connected to the first housing 200, such that the first locking member 351 has the first holding position and the first releasing position. As shown in FIG. 13 to FIG. 15B, the strain relief component 3511 may be pressured when the first locking member 351 is in the first holding position, such that the first conducting assembly 100 is pressed against the first housing 200. Exemplarily, a flexible portion of the first conducting assembly 100, such as an interconnecting portion 111C, may be pressed against the first housing 200. Both the first locking member 351 and the first housing 200 are made of rigid materials. The strain relief component 3511 may relief the stress concentration on the interconnecting portion 111C from the first locking member 351 and the first housing 200. The value of the stress can be adjusted to a certain extent to prevent the flexible flat cable 111 from damaging. The interconnecting portion 111C of the flexible flat cable 111 is able to withstand greater tension than the mating contact end 111A. As shown in FIG. 14B, the first conducting assembly 100, such as the interconnecting portion 111C, is clamped between the strain relief component 3511 and the first housing 200 (such as the rear housing member 202), e.g., in the second lateral direction Z-Z, thereby increasing the frictions among the first conducting assembly 100, the strain relief component 3511 and the first housing 200. The first conducting assembly 100 may be difficult to move under a pulling force in the pull-out direction of the plug connector 10. Optionally, as shown in FIG. 14A, a portion of the interconnecting portion 111C between the first locking member 351 and the contact pads 113 may be bent. Optionally, the mating contact end 111A may be bent under the pressure of the first locking member 351. Thus, the frictions between the flexible flat cable 111 and the first locking member 351 and between the flexible flat cable 111 and the first housing 200 may be increased. Moreover, when the flexible flat cable 111 is subjected to a tension, the tension is uneasily transmitted to the mating contact end 111A, such that the contact pads 113 may be electrically connected with the socket connector 20. In addition, the first locking member 351 biases the interconnecting portion 111C, for example, in the second lateral direction Z-Z, as shown in FIG. 14A, such that the interconnecting portion 111C is offset in relative to the mating contact end 111A toward a side of the first housing 200. Moreover, an enough space may be left on the other side (above the interconnecting portion 111C in the drawing) in the first housing 200 for accommodating a larger first locking member 351 with the strain relief component 3511. The larger first locking member 351 may be assembled and detached more easily, and it allows the first locking member 351 to have beams with higher mechanical strength and greater elasticity. In this way, the first locking member 351 can be reliably installed to the first housing 200. The strain relief component 3511 can adjust the stress on the first conducting assembly 100 over a larger range, and have longer service life.

The first locking member 351 may be mounted to the first housing 200 by direct insertion and held at the first holding position, and the first locking member 351 may be partially or completely separated from the first housing 200 when in the first releasing position. In other embodiments, the first locking member 351 may also be pivotably connected to the first housing 200 between the first holding position and the first releasing position, so that the first conducting assembly 100 is held or released.

The first locking member 351 may, by example, include beams 3512 engaged with the first housing 200, and the beams 3512 may be unengaged with the first housing 200 by using a tool. The beams 3512 may be integrated with the first locking member 351, rather than being assembled onto the first locking member 351. In this way, costs maybe lower. Since the first conducting assembly 100 is detached from the plug connector 10 only when it needs to be replaced or maintained, and not as frequently as the plug connector 10 needs to be connected to and detached from the socket connector 20, the first locking member 351 may be detached by means of a tool. No screw may be required; thus screw loss may not happen during the replacement of the first conducting assembly 100. The user experience can be improved. The beams 3512 are elastically deformed and released by means of the tool. Thus, the beams 3512 can be reliably engaged with the first housing 200 for securing the first conducting assembly 100 onto the first housing 200, not unless an external force is excessively large to destroy the beams 3512. The flexible flat cable 111 cannot be straightened and force the first locking member 351 to divorce from the first housing 200, even if a large pulling force is exerted onto the flexible flat cable 111.

Exemplarily, the first conducting assembly 100 may be clamped or pressured by the first locking member 351 for attaching to the first housing 200. The first conducting assembly 100 may deform, deteriorate, or even break if subjected to a large force from the first locking member 351 for an extended period of time. Exemplarily, the strain relief component 3511 may be made of an elastic material. In this case, the strain relief component 3511 may be properly deformed under pressure. Not only the friction with the first conducting assembly 100 is increased, but also the first conducting assembly 100 cannot be damaged due to excessive hardness.

Exemplarily, the strain relief component 3511 is sleeved on the first locking member 351. As described herein, the strain relief component 3511 may be made of an elastic material. The elastic material may include but not limited to silicone. The strain relief component 3511 is sandwiched between the first conducting assembly 100 and the first locking member 351. The strain relief component 3511 may not fall from the first locking member 351 during the replacement of the first conducting assembly 100. The strain relief component 3511 may be efficiently replaced as needed, as compared to, for example, gluing, by sleeving the strain relief component 3511 on the first locking member 351.

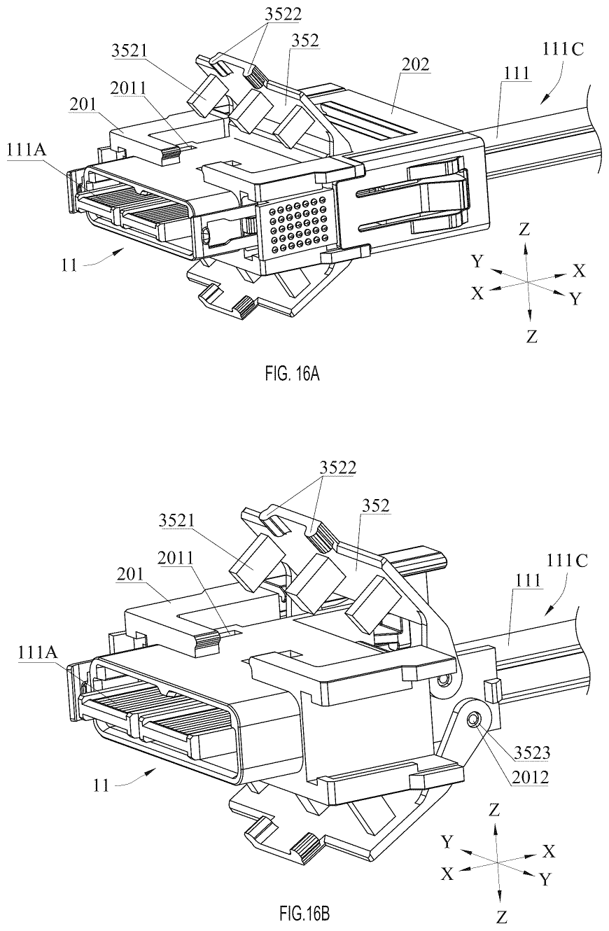

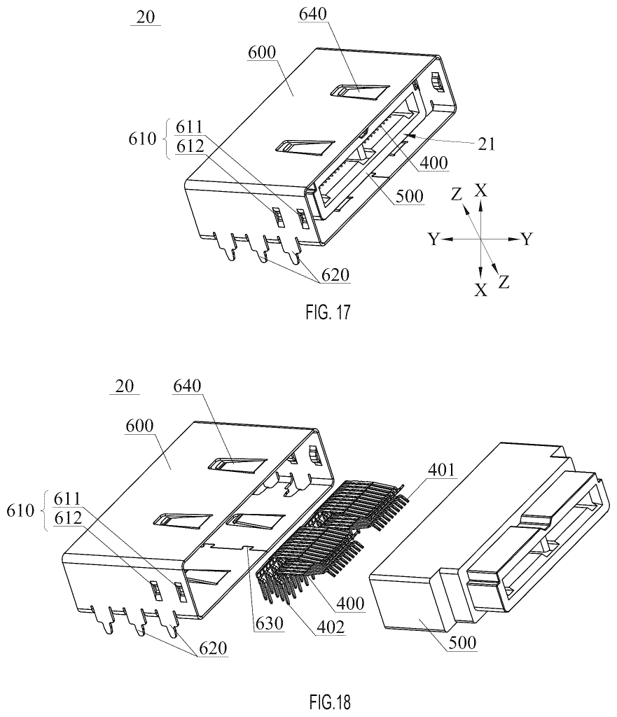

Exemplarily, the TPA device 350 may also include a second locking member 352 having a second holding position and a second releasing position, as shown in FIGS. 16A and 16B. When the second locking member 352 is in a second holding position, the second locking member 352 is fixed to the first housing 200 and engaged with the first conducting assembly 100. When the second locking member 352 is in the second releasing position, the second locking member 352 releases the first conducting assembly 100. As shown in FIGS. 16A and 16B, the second locking member 352 may include a plurality of protrusions 3521, and the first housing 200 may include holes 2011. The holes 2011 receive the protrusions 3521 respectively, when the second locking member 352 is in the second holding position. The protrusions 3521 pass through the holes 2011 to engage with the first conducting assembly 100. As described herein, the first conducting assembly 100 may be inserted into the plug connector 10 along the guide slot 203. The first conducting assembly 100 may comprise grooves engaged with the protrusions 3521. The protrusions 3521 may be inserted into the grooves after the first conducting assembly 100 is in place, so as to limit the movement of the first conducting assembly 100. Thus, the first conducting assembly 100 may be positioned. The structure is simpler.

Exemplarily, an edge of the reinforcing plate 112 may be arranged with a cut 114 for receiving the second locking member 352. The cut 114 is positioned on the edge of the reinforcing plate 112 to avoid having an effect on the shape of the mating contact end 111A. In this way, the design difficulty may be significantly reduced, and the space utilization is relatively higher.

Exemplarily, the second locking member 352 is pivotally connected to the first housing 200 between the second holding position and the second releasing position. As shown in FIG. 16A, exemplarily, the second locking member 352 may be installed to the first housing 200, and be pivotable between the second holding position and the second releasing position around a shaft. FIG. 16B shows the second locking member 352 having a pivot hole 3523. Exemplarily, the shaft may be a projection 2012 formed on the first housing 200, and the projection 2012 may be inserted into the pivot hole 3523 of the second locking member 352. Optionally, an opening may be arranged in the first housing 200, and a projection may be provided on the second locking member 352. The projection of the second locking member 352 is inserted into the opening of the first housing 200. In other embodiments not shown, a separate shaft may be inserted into holes and/or openings of the second locking member and the first housing, such that the second locking member is pivotally connected to the first housing. The pivoting connection allows for easy operation. The second locking member 352 is non-detachable from the first housing 200 and is uneasy to lose. The second locking member 352 may include a protruding portion 3522, which is engaged with the first housing 200 when the second locking member 352 is in the second holding position. For example, an external force is needed to move the second locking member 352 to the second releasing position. This may effectively prevent the second locking member 352 from accidentally moving to the second releasing position.

Exemplarily, along a lateral direction perpendicular to the mating direction X-X of the plug connector 10 to the socket connector 20, such as the second lateral direction Z-Z, the first housing 200 has opposite first and second sides. There are two second locking members 352 and the second locking members 352 are substantially symmetrically attached onto the first and second sides. In the embodiments as shown, the first conducting assemblies 100 may be substantially symmetrical along the second lateral direction Z-Z. The plug connector 10 may include four first conducting assemblies 100, thereby significantly increasing the density of the plug connector 10. Two second locking members 352 on two sides are used for positioning the first conducting assemblies 100, respectively. Thus, some first conducting assemblies 100 are mounted into the first housing 200 on one side, and locked by a second locking member 352 on the corresponding side; and then other first conducting assemblies 100 are mounted into the first housing 200 on the other side, and locked by a second locking member 352 on the corresponding side. During assembling, the plug connector 10 may always be placed on a plane, and the second locking member 352 facing on the plane may be in the second holding position. In the symmetric arrangement, the projections 2012 on the first housing 200 engaged with the pivot holes 3523 may be staggered in order to avoid interference. For example, embodiments with a first conducting assembly 100 only on one side are not excluded. In this case, the second locking member 352 may be unnecessary to be symmetrical.

Exemplarily, the first locking member 351 is connected to the rear housing member 202, and the second locking member 352 is connected to the front housing member 201. The mating contact end 111A extends to the front housing member 201, so that the plug connector 10 may not be inserted deeply into the socket connector 20 to electrically connect with the socket connector 20. The first conducting assembly 100 may be fixed to the rear housing member 202 by the first locking member 351, and also fixed to the front housing member 201 by the second locking member 352, such that the first conducting assembly 100 is positioned uniformly and reliably. As described herein, the first locking member 351 and the second locking member 352 may lock the first conducting assembly 100 in diverse ways.

In some embodiments, a socket connector 20 is provided, which comprise a second conducting assembly, a second housing 500 and a cage 600. The second conducting assembly includes a plurality of terminals 400 configured for electrical connection with a plurality of contact pads 113 of a plug connector 10 inserted to the socket connector 20. The plurality of terminals 400 are held by the second housing 500. The cage 600 may enclose at least portion of the second housing 500. The cage 600 may comprise a connector locking portion 610 configured for engaging with the CPA device 300 of the plug connector 10.

The socket connector 20 may, for example, be mated to the plug connector 10 above. The socket connector 20 establishes an electrical connection between a circuit board to be installed (not shown) and the mating connector. The circuit board to be installed may be the first circuit board (also referred to as the “first printed circuit board” or “first PCB”). The socket connector 20 may be installed to the circuit board. Conductive portions of the plug connector 10 may be inserted into the socket connector 20, so that the circuit board may be electrically connected to the plug connector 10 through the socket connector 20.

In embodiments not shown, the socket connector may also mate with another electrical component, such as second circuit board (also referred to as “second printed circuit board” or “second PCB”). In this case, the first circuit board may be a motherboard, and the second circuit board may be a daughter card such as solid state disk (SSD) card, wireless communication card, RF module. The electrical connector may be installed to the first circuit board, and corresponding conductive portions of the second circuit board may be inserted into the socket connector, such that the first circuit board may be electrically connected to the second circuit board via the socket connector.

The second housing 500 may be molded with insulating materials. The insulating materials which are suitable for manufacturing the second housing 500 may include but not limited to plastics, liquid crystal polymers (LCP), polyphenylene sulfite (PPS), high-temperature nylon or poly-p-phenylene oxide (PPO), or polypropylene (PP). In order to describe clearly and concisely, the mating direction X-X, the first lateral direction Y-Y and the second lateral direction Z-Z continue to be used hereinafter. Exemplarily, the cage 600 encloses the second housing 500. The cage 600 and the second housing 500 together form a second mating portion 21 for mating with the first mating portion 11 of the plug connector 10. At the second mating portion 21, the cage 600 may extend beyond the second housing 500. The longer cage 600 provides better support for the plug connector 10 when the plug connector 10 is mated with the mating plug connector 10. Compared to the second housing 500 or the first housing 200 of the plug connector 10, the cage 600 may withstand greater external forces. The mating positions of the plug connector 10 and socket connector 20 are prevented from being broken by external forces. Optionally, the cage 600 may be fixed to the first circuit board by adhesives, welds, protrusions, etc., to support and position the second housing 500. The cage 600 may be connected to signal ground, so that it may form an effective shield against external interference.

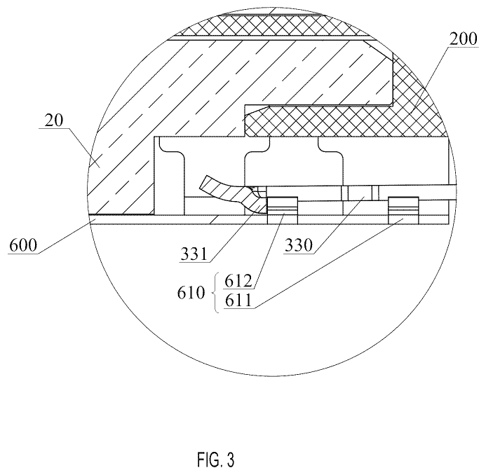

In the embodiment shown in FIG. 3, the connector locking portion 610 on the cage 600 may be a projection formed by stamping. When the plug connector 10 is connected to the socket connector 20, the third locking part 331 of the third member 330 may be hooked to the connector locking portion 610, such that the plug connector 10 cannot be accidentally separated from the socket connector 20. In other embodiments, the connector locking portion 610 may have any other configuration, provided that it may be engaged to the third locking part 331. This ensures a reliable connection between the plug connector 10 and the socket connector 20 at low costs.

Exemplarily, the connector locking portion 610 may include a first connector locking portion 611 and a second connector locking portion 612. The first connector locking portion 611 and the second connector locking portion 612 are spaced apart along the mating direction of the plug connector 10 to the socket connector 20. Each of the first connector locking portion 611 and the second connector locking portion 612 is capable of locking with the CPA device 300 on the plug connector 10.

Continue to refer to FIG. 3, the second connector locking portion 612 is deeper in the cage 600 than the first connector locking portion 611 along the mating direction. In this way, only when the plug connector 10 is tightly inserted into the socket connector 20 in place, the third locking part 331 may be engaged with the second connector locking portion 612. The first connector locking portion 611 is closer to the outer side relative to the second connector locking portion 612. When the third locking part 331 fails to get stuck by the second connector locking portion 612, the first connector locking portion 611 may further prevent the plug connector 10 from completely unmating with the socket connector 20. At least portion of the contact pads 113 and/or at least portion of the terminals 400 for transmitting signals may be shorter, such that the electrical connection between the at least portion of the contact pads 113 and corresponding terminals 400 and/or between the at least portion of terminals 400 and corresponding the contact pads 113 may fail when the plug connector 10 is loose but not separated from the socket connector 20. An alarm signal is generated. This further prevents the plug connector 10 and socket connector 20 from being accidentally disconnected.

For example, during an initial insertion of the plug connector 10 into the socket connector 20 by the user, the friction resistance may gradually increase. Therefore, the user may mistakenly believe that the plug connector 10 has been inserted in place. In this case, the third locking part 331 of the third member 330 may only contact with and be not completely locked with the second connector locking portion 612. While the automobile is in motion, the plug connector 10 may become loose due to vibration. During the unmating of the plug connector 10 from the socket connector 20, the third locking part 331 may also cooperate with the first connector locking portion 611, thereby preventing accidental disconnection of the plug connector 10 and the socket connector 20. In short, even if the third locking part 331 and the second connector locking portion 612 are accidentally separate for any reason, for example, the vibration being too severe, the plug connector 10 being not properly connected to the socket connector 20 by the user, or the second connector locking portion 612 being damaged, the plug connector 10 cannot disconnect from the socket connector 20 absolutely by the first connector locking portion 611.

As shown in FIG. 18, the plurality of terminals 400 each may be formed by a conductive material. The conductive material suitable for the terminals 400 may be metal or metal alloy, such as copper or copper alloy. Electrical contact ends 401 of the terminals 400 may be configured for mating with corresponding conductive parts of an electrical component, such as the second circuit board and the plug connector described herein, and mounting ends 402 of the terminals 400 may be configured for installing to a circuit board, such as the first circuit board described herein. The mounting ends 402 may be straight in the second lateral direction Z-Z. Optionally, the first circuit board may include conductive parts such as conductive pads or conductive vias, and the mounting ends 402 of the terminals 400 may be connected to the conductive parts of the first circuit board by any suitable process known in the prior art, such as pressure mounting or welding. For example, the second circuit board may include conductive parts arranged at or near an edge thereof and be inserted into the socket connector such that the conductive parts of the second circuit board are in contact with the electrical contact ends 401 of the terminals 400, respectively.

The plurality of terminals 400 each may include a bend such that the mounting end 402 and the electrical contact end 401 of the terminal 400 are substantially perpendicular to each other. When the terminals 400 are held by the second housing 500, the mounting ends 402 are oriented along the second lateral direction Z-Z, and the electrical contact ends 401 are oriented along the mating direction X-X. With this arrangement, the socket connector 20 may be installed to the circuit board along the second lateral direction Z-Z, and mated with the plug connector along the mating direction X-X, so that an electrical connection is established between the plug connector and the circuit board. Optionally, the mounting ends 402 and the electrical contact ends 401 may also extend oppositely along the mating direction X-X, such that the terminal 400 each is generally straight.

Exemplarily, the second housing 500 may be over-molded onto the terminals 400. In some embodiments, the second housing 500 may also include a mounting assembly (not shown) for separating the mounting ends 402 of the terminals 400 from each other. Optionally, in some embodiments, the second housing 500 includes a main body, and the main body has a reserved recess in a rear portion thereof. The terminals 400 may be installed onto the main body of the second housing 500 through the recess, and plastic material then is injected into the recess.

Exemplarily, the cage 600 may be formed by a metal sheet, and opposite edges of the metal sheet have mortise and tenon 630 respectively so that the edges of the metal sheet are connected to each other. Continuing with FIG. 18, the cage 600 completely wraps the second housing 500 of socket connector 20. Optically, a metal sheet may be stamped with a suitable shape to form a semi-finished product, then the assembled second housing 500 and terminals 400 are put onto the semi-finished product, and the semi-finished product is bent into the cage 600. The cage 600 may completely wrap the second housing 500. For example, the mortise and tenon 630 may be arranged at a lower part of the cage 600. The edges of the metal sheet are connected to each other after the metal sheet is bent, so as to form the cage 600 that can withstand a force parallel to the metal sheet. Compared with welding, the metal sheet may be rapidly stamped with the mortise and tenon 630 in large quantities. Thus, costs are lower, and reliability and yield are higher.

Exemplarily, the cage 600 may include a board lock 620 for fixing to a second circuit board. As described herein, the cage 600 may be fixed to the first circuit board. Since the socket connector 20 may be subjected to a pull force when mating with the plug connector 10, there are requirements for the connection strength between the cage 600, which is mainly subjected to the pull force, and the first circuit board. Exemplarily, the cage 600 may be fixed to the first circuit board by welding. In some embodiments, a surface of the cage 600 may be reliably fixed to the first circuit board by tin-soldering. In one preferred embodiment, the cage 600 includes a board lock 620 consisting of a metal protrusion from a surface of the cage 600. The board lock 620 may be inserted into and tin-soldered to a pad/via and/or through-hole of the first circuit board such that the cage 600 is firmly secured to the first circuit board. The board lock 620 may be press-fitted into the pad/via of the first circuit board. The pad/via may be slightly larger than the board lock 620. After the board lock 620 is inserted into the pad/via of the first circuit board, the gap between the board lock 620 and the via may be filled by soldering tin, such that the board lock 620 may be reliably fixed. Compared to the embodiments in which the cage 600 is welded directly to the first circuit board, with the aid of the board lock 620, portions of the cage 600 to be welded are unnecessary to be heated, thus reducing the process difficulty. Moreover, the force applied to the cage 600 may spread out on the substrate of the first circuit board by pressing the board lock 620 into the first circuit board, such that the pad cannot be separated from the substrate of the first circuit board. Exemplarily, an end of the board lock 620 may have a reduced dimension to form a step at a level nearly flush with the lower surface of the cage 600. It allows the slender end of the board lock 620 to be inserted into the pad/via of the first circuit board, and the step to be stuck on the surface of the first circuit board, such that the cage 600 is limited in position and unskewed.

Exemplarily, the inner surface of the front part of the cage 600 is spaced apart from the outer surface of the second housing 500 to form a space for receiving an insertion portion of the plug connector 10. The connector locking portion 610 is arranged in the space. Exemplarily, the second housing 500 may include a front part that cooperates with the front part of the cage 600 to form the second mating portion 21 and a rear part for fixing the terminals 400, as shown in FIG. 18. The rear part of the cage 600 is fixed to the rear part of the second housing 500 which fits to the cage 600 in dimensions. The cage 600 may also be fixed to the rear part of the second housing 500 by means of protrusions or resilient sheet 640. The front part of the second housing 500 is smaller than the cage 600, such that the space is formed between the front parts of the second housing 500 and the cage 600 for receiving the first mating portion 11 of the plug connector 10. When the second mating portion 21 is connected to the first mating portion 11 of the plug connector 10, the first mating portion 11 may be inserted into the cage 600, and the front part of the second housing 500 is inserted into the first mating portion 11.

The application also provides a method for operating a plug connector. The method may include the following steps: moving a first member from a first locked state to a first unlocked state to release a second member in a second locked state; and moving the second member from the second locked state to a second unlocked state to release a third member, wherein: when the second member is in the second locked state, the third member is in a third locked state; and, when the second member is in the second unlocked state, the third member is in a third unlocked state to release a socket connector mated to the plug connector.

Exemplarily, the step of moving the first member from the first locked state to the first unlocked state may include: pressing a first actuator C of the first member in the first locked state; and, moving the first member along a first direction such that the first member moves to the first unlocked state.

The application also provides a method for replacing a first conducting assembly of a plug connector. The method may include the following steps: moving a first locking member to a first releasing position, wherein the first locking member has a strain relief component that releases the first conducting assembly when the first locking member is in the first releasing position; removing the first conducting assembly; replacing a first conducting assembly; and moving the first locking member to the first holding position, wherein the strain relief component abuts against the replaced first conducting assembly.

Exemplarily, prior to the step of removing the first conducting assembly, the method for replacing the first conducting assembly may also include: moving a second locking member to a second releasing position, such that the second locking member disengages the first conducting assembly. After the step of replacing the first conducting assembly, the method may also include moving the second locking member to a second holding position where the second locking member is engaged with the first conducting assembly.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

In the description of the present disclosure, it is to be understood that orientation or positional relationships indicated by orientation words “front”, “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. A cable connector, comprising:
a housing;
a conducting assembly at least partially disposed inside the housing; and
a connector position assurance (CPA) device separated from the conducting assembly by the housing, the CPA device comprising:
a first member disposed on the housing and movable between a first locked state and a first unlocked state,
a second member disposed on the first member and movable between a second locked state and a second unlocked state, wherein, when the first member is in the first locked state, the first member blocks the second member from moving from the second locked stated to the second unlocked state, and
a third member disposed between the first member and the second member and configured to releasably engage a mating component.

2. The cable connector of claim 1, wherein:
the first member is movable in a mating direction in the first unlocked state; and
the second member is pivotable in the second unlocked state.

3. The cable connector of claim 2, wherein:
the third member is movable between a third locked state and a third unlocked state; and
the third member is in the third locked states when the first and second members are in the first and second locked state, and in the third unlocked state when the second member is pivoted to engage the third member.

4. The cable connector of claim 1, wherein:
the first and second members comprise plastic; and
the third member comprises metal.

5. The cable connector of claim 1, wherein:
the housing comprises a front housing member and a rear housing member;
the first member is disposed on the rear housing member and extends to the front housing member;
the second member is disposed on the front housing member; and
the third member is disposed in the rear housing member and extends through the first member to the front housing member.

6. The cable connector of claim 2, wherein:
the first member comprises a first body comprising a first actuator operable between a rest position and a first actuated position, and a first locking part configured to engage the second member when the first member is in the first locked state;
the first actuator is blocked by the housing in the mating direction when the first actuator is in the rest position; and
the first actuator is unblocked by the housing when the first actuator is in the first actuated position, such that the first member is movable in the mating direction the first unlocked state.

7. The cable connector of claim 6, wherein:
the first actuator comprises a cantilever and a pair of wings protruding from opposite sides of a free end of the cantilever, respectively; and
the housing comprises a pair of limiters configured to block the pair of wings in the mating direction, respectively.

8. The cable connector of claim 6, wherein:
the first member further comprises a first intermediate part between the first locking part and the first body, the first intermediate part comprising a gap;
the third member comprises a third locking part configured to secure to the mating component, a third tail, and a third intermediate part between the third locking part and the third tail; and
the third intermediate part is narrower than both the third locking part and at least part of the third tail, and extends through the gap of the first intermediate part of the first member.

9. The cable connector of claim 8, wherein:
the third member comprises a third opening elongated in the mating direction; and
the first locking part is configured to engage the second member through the third opening in the first locked state and be slidable in the third opening in the first unlocked state.

10. The cable connector of claim 1, wherein:
the first and second members are configured to engage each other in the first and second locked states and to disengage each other in the first and second unlocked states.

11. A cable connector, comprising:
a housing; and
a conducting assembly removably connected to the housing, the conducting assembly comprising one or more flexible flat cables having a mating contact end extending into the housing, a mounting end disposed outside the housing, and an interconnecting portion between the mating contact end and the mounting end, wherein:
the mating contact end of the one or more flexible flat cables has a first surface and a second surface;
each of the first surface and the second surface comprises a plurality of contact pads arranged in a row parallel to a first direction; and
the first surface and the second surface are opposite each other in a second direction perpendicular to the first direction.

12. The cable connector of claim 11, comprising:
a terminal position assurance (TPA) device configured to secure the conducting assembly to the housing in a locked state and allow the removal of the conducting assembly in an unlocked state, wherein:
the TPA device comprises a first locking member removably connected to the housing, and a strain relief component arranged on the first locking member, and a second locking member pivotably connected to the housing, the second locking member engaging the conducting assembly and configured to pivot to disengage the conducting assembly.

13. The cable connector of claim 12, wherein:
the first locking member includes a beam engaging the housing and configured to disengage the housing by a tool.

14. The cable connector of claim 12, wherein:
the strain relief component is sleeved on the first locking member; and/or
the strain relief component comprises an elastic material.

15. The cable connector of claim 12, wherein:
the interconnecting portion is clamped between the housing and the strain relief component;
the conducting assembly comprises a reinforcing plate having a cut configured for receiving the second locking member; and
the mating contact end of the one or more flexible flat cables is attached to the reinforcing plate.

16. A cable connector comprising:
a housing; and
a conducting assembly removably connected to the housing, the conducting assembly comprising one or more flexible flat cables having a mating contact end extending into the housing, a mounting end disposed outside the housing, and an interconnecting portion between the mating contact end and the mounting end; and
a terminal position assurance (TPA) device mechanically engaging the one or more flexible flat cables so as to block withdrawal of the conducting assembly.

17. The cable connector of claim 16, wherein:
the TPA device comprises a first locking member removably connected to the housing, and a strain relief component arranged on the first locking member and pressing the one or more flexible flat cables against the housing.

18. The cable connector of claim 17, wherein:
the TPA device comprises a second locking member pivotably connected to the housing, the second locking member engaging the conducting assembly and configured to pivot to disengage the conducting assembly.

19. The cable connector of claim 18, wherein:
the housing comprises a front housing member and a rear housing member, and the conducting assembly passes through the rear housing member and extends into the front housing member;
the first locking member is removably connected to the rear housing member; and
the second locking member is pivotably connected to the front housing member.

20. The cable connector of claim 19, wherein:
the TPA device is disposed from a top of the housing;
the cable connector comprise a connector position assurance (CPA) device disposed from a side of the housing and separated from the conducting assembly by the housing; and
the CPA device comprises a first member disposed on the rear housing member and extending to the front housing member, a second member disposed on the front housing member, and a third member disposed in the rear housing member and extending through the first member to the front housing member.
